(19) United States
(12) Patent Application Publication
(10) Pub. No.: US 2012/0200345 A1
(43) Pub. Date: Aug. 9, 2012

(54) INTEGRATED CIRCUIT HAVING POWER GATING FUNCTION AND SEMICONDUCTOR DEVICE INCLUDING THE SAME

(75) Inventor: Jung-Sik KIM, SEOUL (KR)

(73) Assignee: SAMSUNG ELECTRONICS CO., LTD., SUWON-SI (KR)

(21) Appl. No.: 13/367,411

(22) Filed: Feb. 7, 2012

(30) Foreign Application Priority Data
Feb. 8, 2011 (KR) 10-2011-0010983

(51) Int. Cl. G05F 3/02

(52) U.S. Cl. 327/543

(57) ABSTRACT

An integrated circuit includes a logic circuit and a power gating circuit. The logic circuit generates an output signal based on an input signal and a first power supply voltage in a normal operation mode, and maintains a voltage level of the output signal as a stand-by logic level based on a second power supply voltage in a stand-by mode. A magnitude of the second power supply voltage is smaller than a magnitude of the first power supply voltage. The power gating circuit entirely applies the first power supply voltage to the logic circuit based on a power gating signal in the normal operation mode, and partially applies the second power supply voltage to the logic circuit based on the power gating signal in the stand-by mode.

### CROSS-REFERENCE TO RELATED APPLICATION

A claim of priority under 35 USC §119 has been made to Korean Patent Application No. 2011-0010983, filed on Feb. 8, 2011, the entirety of which is incorporated herein by reference in its entirety.

### BACKGROUND OF THE INVENTION

The inventive concepts herein relate to an integrated circuit, and more particularly, relate to an integrated circuit having a power gating function and a semiconductor device including the integrated circuit.

Semiconductor devices are typically required to be of small size and light weight, whereby the number of required function blocks within the semiconductor devices has increased. Generally, since semiconductor devices are required to operate with limited power (e.g., using an embedded battery), power consumption of the semiconductor device should be reduced by adopting a stand-by mode. To reduce power consumption, the semiconductor device may include a power gating circuit that prevents power from being provided to the function blocks in the stand-by mode. However, when power is blocked to the function blocks during the stand-by mode, data within the function blocks may be lost.

### SUMMARY

Accordingly, the inventive concept is provided to substantially obviate one or more problems due to limitations and disadvantages of the related art.

Some example embodiments provide an integrated circuit capable of reducing power consumption of a logic circuit in a stand-by mode, and capable of retaining data of the logic circuit in the stand-by mode without any additional device.

Some example embodiments provide a semiconductor device including the integrated circuit that has power gating function.

According to some example embodiments, an integrated circuit having power gating function includes a logic circuit and a power gating circuit. The logic circuit generates an output signal based on an input signal and a first power supply voltage in a normal operation mode, and maintains a voltage level of the output signal as a stand-by logic level based on a second power supply voltage in a stand-by mode. A magnitude of the second power supply voltage is smaller than a magnitude of the first power supply voltage. The power gating circuit entirely applies the first power supply voltage to the logic circuit based on a power gating signal in the normal operation mode, and partially applies the second power supply voltage to the logic circuit based on the power gating signal in the stand-by mode.

The power gating circuit may include a first power gating unit. The first power gating unit may apply a first positive power supply voltage of the first power supply voltage to all regions of the logic circuit based on the power gating signal in the normal operation mode, and may apply a second positive power supply voltage of the second power supply voltage to an active region of the logic circuit based on the power gating signal in the stand-by mode. The active region may be a part of the logic circuit activated to maintain the voltage level of the output signal in the stand-by mode.

The power gating signal may include a stand-by mode enable signal. The first power gating unit may include a first switch unit and a second switch unit. The first switch unit may provide the first positive power supply voltage to all regions of the logic circuit when the stand-by mode enable signal is deactivated. The second switch unit may generate the second positive power supply voltage by decreasing a magnitude of the first positive power supply voltage to provide the second positive power supply voltage to the active region of the logic circuit when the stand-by mode enable signal is activated.

In an example embodiment, the first switch unit may include a p-type transistor having a gate electrode receiving the stand-by mode enable signal and connected between the first positive power supply voltage and the logic circuit. The second switch unit may include at least one n-type transistor connected serially between the first positive power supply voltage and the logic circuit. Each of the at least one n-type transistor may have a gate electrode receiving the stand-by mode enable signal.

In another example embodiment, the first switch unit may include a first p-type transistor having a gate electrode receiving the stand-by mode enable signal and connected between the first positive power supply voltage and the logic circuit. The second switch unit may include a second p-type transistor and at least one diode. The second p-type transistor may have a gate electrode receiving an inversion signal that is an inverted version of the stand-by mode enable signal and connected to the first positive power supply voltage. The at least one diode may be connected serially between the second p-type transistor and the logic circuit.

The power gating circuit may further include a second power gating unit. The second power gating unit may apply a first negative power supply voltage of the first power supply voltage to all regions of the logic circuit based on the power gating signal in the normal operation mode, and may apply a second negative power supply voltage of the second power supply voltage to the active region of the logic circuit based on the power gating signal in the stand-by mode.

The power gating signal may include a stand-by mode enable signal. The second power gating unit may include a first switch unit and a second switch unit. The first switch unit may provide the first negative power supply voltage to all regions of the logic circuit when an inversion signal that is an inverted version of the stand-by mode enable signal is activated. The second switch unit may generate the second negative power supply voltage by decreasing a magnitude of the first negative power supply voltage to provide the second negative power supply voltage to the active region of the logic circuit when the inversion signal of the stand-by mode enable signal is deactivated.

The first switch unit may include a n-type transistor having a gate electrode receiving the inversion signal of the stand-by mode enable signal and connected between the first negative power supply voltage and the logic circuit. The second switch unit may include at least one p-type transistor connected serially between the first negative power supply voltage and the logic circuit. Each of the at least one n-type transistor may have a gate electrode receiving the inversion signal of the stand-by mode enable signal.

The logic circuit may include an active region that is a part of the logic circuit activated to maintain the voltage level of the output signal in the stand-by mode. The active region of the logic circuit may include at least one p-type transistor and at least one n-type transistor. The at least one p-type transistor may be maintained to be turned on in the stand-by mode. Each of the at least one p-type transistor may have a second positive power supply voltage of the second power supply voltage from the power gating circuit at a drain electrode and a source electrode. The at least one n-type transistor may be maintained to be turned on in the stand-by mode. Each of the at least one n-type transistor may have a first gate voltage provided from the drain electrode of a respective one of the at least one p-type transistor. The first gate voltage may correspond to the second positive power supply voltage.

Each of the at least one n-type transistor may have a second negative power supply voltage of the second power supply voltage from the power gating circuit at a drain electrode and a source electrode. Each of the at least one p-type transistor may have a second gate voltage provided from the drain electrode of a respective one of the at least one n-type transistor. The second gate voltage may correspond to the second negative power supply voltage.

The logic circuit may further include an inactive region that is another part of the logic circuit deactivated in the stand-by mode. The inactive region of the logic circuit may include at least one transistor turned off in the stand-by mode. The power gating circuit may electrically isolate the inactive region of the logic circuit from the first power supply voltage in the stand-by mode.

The power gating circuit may include a first power gating unit and a second power gating unit. The first power gating unit may electrically isolate the inactive region of the logic circuit from a first positive power supply voltage of the first power supply voltage in the stand-by mode. The second power gating unit may electrically isolate the inactive region of the logic circuit from a first negative power supply voltage of the first power supply voltage in the stand-by mode.

The first power supply voltage may include a first positive power supply voltage and a first negative power supply voltage. The second power supply voltage may include a second positive power supply voltage and a second negative power supply voltage. The logic circuit may include an inverter chain having first inverters and second inverters that are cascaded-coupled. The power gating circuit may apply the first positive power supply voltage and the first negative power supply voltage to the first and second inverters in the normal operation mode, may apply the second positive power supply voltage instead of the first positive power supply voltage to the first inverters in the stand-by mode, and may apply the second negative power supply voltage instead of the first negative power supply voltage to the second inverters in the stand-by mode. An output terminal of each first inverter may be maintained at a logic high level, and an output terminal of each second inverter may be maintained at a logic low level.

The power gating circuit may electrically isolate the first inverters from the first negative power supply voltage and may electrically isolate the second inverters from the first positive power supply voltage.

According to other example embodiments, a semiconductor device includes a control circuit and an integrated circuit having a power gating function. The control circuit generates a power gating signal activated in a normal operation mode and deactivated in a stand-by mode. The integrated circuit is controlled based on the power gating signal. The integrated circuit includes a logic circuit and a power gating circuit. The logic circuit generates an output signal based on an input signal and a first power supply voltage in the normal operation mode, and maintains a voltage level of the output signal as a stand-by logic level based on a second power supply voltage in the stand-by mode. A magnitude of the second power supply voltage may be smaller than a magnitude of the first power supply voltage. The power gating circuit entirely applies the first power supply voltage to the logic circuit based on the power gating signal in the normal operation mode, and partially applies the second power supply voltage to the logic circuit based on the power gating signal in the stand-by mode.

According to still other example embodiments, a semiconductor device includes a logic circuit and a power gating circuit. The logic circuit generates an output signal based on an input signal in a normal operation mode, and maintains a voltage level of the output signal as a stand-by logic level in a stand-by mode. The power gating circuit includes a first power gating unit, a second power gating unit, a third power gating unit and a fourth power gating unit. The first power gating unit selectively applies a first positive power supply voltage or a second positive power supply voltage to a first circuit region of the logic circuit responsive to a stand-by mode enable signal. The second positive power supply voltage is smaller than the first positive power supply voltage. The second power gating unit selectively applies the first positive power supply voltage to a second circuit region of the logic circuit or to electrically isolate the second circuit region from the first positive power supply voltage, responsive to the stand-by mode enable signal. The third power gating unit selectively applies a first negative power supply voltage or a second negative power supply voltage to the second circuit region of the logic circuit responsive to a stand-by mode disable signal. The second negative power supply voltage is smaller than the first negative power supply voltage. The fourth power gating unit selectively applies the first negative power supply voltage to the first circuit region of the logic circuit or to electrically isolate the first circuit region from the first negative power supply voltage, responsive to the stand-by mode disable signal.

The first power gating unit comprises a first p-type transistor and a first n-type transistor each having a gate electrode connected to the stand-by mode enable signal, and each respectively connected serially between the first positive power supply voltage and the first circuit region of the logic circuit.

The second power gating circuit comprises a second p-type transistor having a gate electrode connected to the stand-by mode enable signal, and connected serially between the first positive power supply voltage and the second circuit region of the logic circuit.

The third power gating unit comprises a first p-type transistor and a first n-type transistor each having a gate electrode connected to the stand-by mode disable signal, and each respectively connected serially between the first negative power supply voltage and the second circuit region of the logic circuit.

The fourth power gating circuit comprises a second n-type transistor having a gate electrode connected to the stand-by mode disable signal, and connected serially between the first negative power supply voltage and the first circuit region of the logic circuit.

Accordingly, in the integrated circuit according to example embodiments, the power gating circuit partially applies the second power supply voltage instead of the first power supply voltage to the active region of the logic circuit in the stand-by mode. The magnitude of the second power supply voltage is smaller than the magnitude of the first power supply voltage. In addition, the power gating circuit may electrically isolate the inactive region of the logic circuit from the first power supply voltages in the stand-by mode. Thus, in the stand-by mode, a leakage current in the logic circuit may be reduced, and the integrated circuit may have relatively low power consumption and may effectively retain an output data of the logic circuit.

### BRIEF DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 is a block diagram illustrating an integrated circuit according to some example embodiments;

FIG. 2 is a block diagram illustrating an example of the integrated circuit of FIG. 1;

FIGS. 3 and 4 are diagrams illustrating examples of the integrated circuit of FIG. 2;

FIG. 5 is a block diagram illustrating another example of the integrated circuit of FIG. 1;

FIG. 6 is a diagram illustrating an example of the integrated circuit of FIG. 5;

FIGS. 7A, 7B, 7C, 7D and 7E are circuit diagrams illustrating examples of a first power gating unit included in the integrated circuit of FIG. 1;

FIGS. 8A, 8B, 8C, 8D and 8E are circuit diagrams illustrating examples of a second power gating unit included in the integrated circuit of FIG. 1;

FIG. 9 is a circuit diagram illustrating another example of the integrated circuit of FIG. 5;

FIG. 10 is a block diagram illustrating still another example of the integrated circuit of FIG. 1;

FIGS. 11 and 12 are diagrams illustrating examples of the integrated circuit of FIG. 10;

FIG. 13 is a diagram for describing an operation of the integrated circuit of FIG. 12;

FIG. 14 is a circuit diagram illustrating another example of the integrated circuit of FIG. 10; and

FIG. 15 is a block diagram illustrating a semiconductor device according to some example embodiments.

### DETAILED DESCRIPTION OF THE EMBODIMENTS

Various example embodiments of the inventive concept will be described more fully with reference to the accompanying drawings. The inventive concepts may, however, be embodied in many different forms and should not be construed as limited to the embodiments set forth herein. Rather, these embodiments are provided so that this disclosure will be thorough and complete, and will fully convey the scope of the inventive concept to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

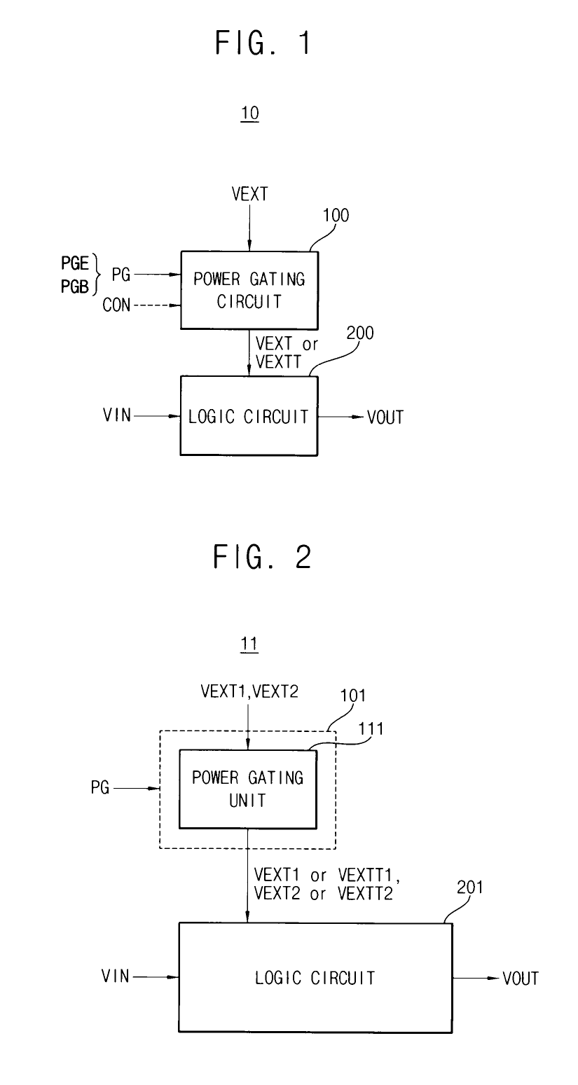

FIG. 1 is a block diagram illustrating an integrated circuit according to some example embodiments of the inventive concept.

Referring to FIG. 1, an integrated circuit 10 includes a power gating circuit 100 and a logic circuit 200. The logic circuit 200 generates an output signal VOUT based on an input signal VIN and a first power supply voltage VEXT in a normal operation mode, and maintains a voltage level of the output signal VOUT as a stand-by logic level based on a second power supply voltage VEXTT in a stand-by mode. A magnitude of the second power supply voltage VEXTT is smaller than a magnitude of the first power supply voltage VEXT. For example, an absolute value of the second power supply voltage VEXTT may be smaller than an absolute value of the first power supply voltage VEXT. The logic circuit 200 may include at least one transistor and/or at least one logic element.

The integrated circuit 10 may operate alternatively in two modes, that is, the normal operation mode and in the stand-by mode. The normal operation mode may be referred to as an active mode, and the stand-by mode may be referred to as a sleep mode. The integrated circuit 10 may perform different operations depending on the operation modes. For example, in the normal operation mode, the integrated circuit 10 may perform predetermined logic operations based on a relatively high power (e.g., the first power supply voltage VEXT) to generate the output signal VOUT such that the logic level of the output signal VOUT is varied based on the input signal VIN. In the stand-by mode, the integrated circuit 10 may not perform additional logic operations and may maintain the logic level of the output signal VOUT based on a relatively low power (e.g., the second power supply voltage VEXTT), thereby reducing power consumption. The operation mode of the integrated circuit 10 may be changed based on a power gating signal PG.

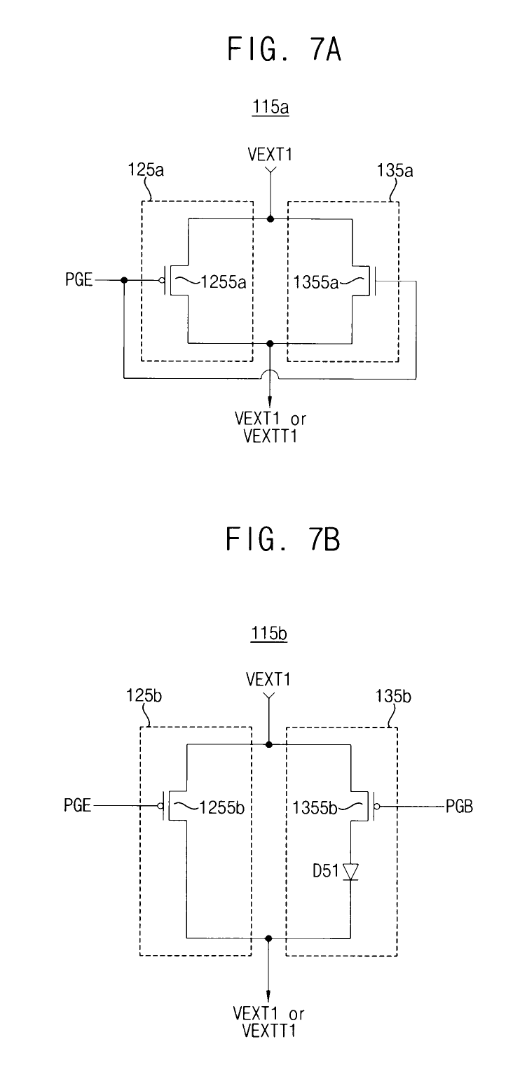

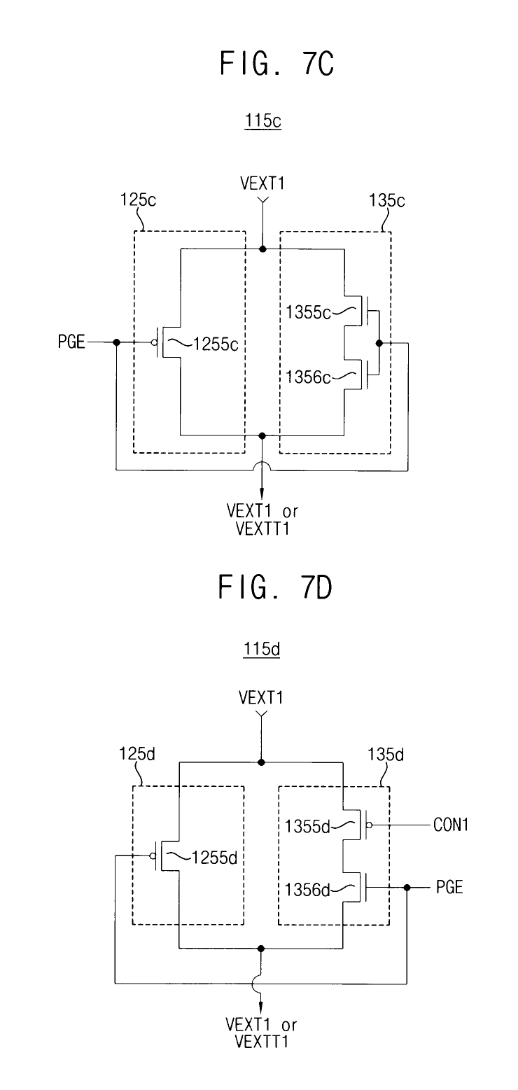

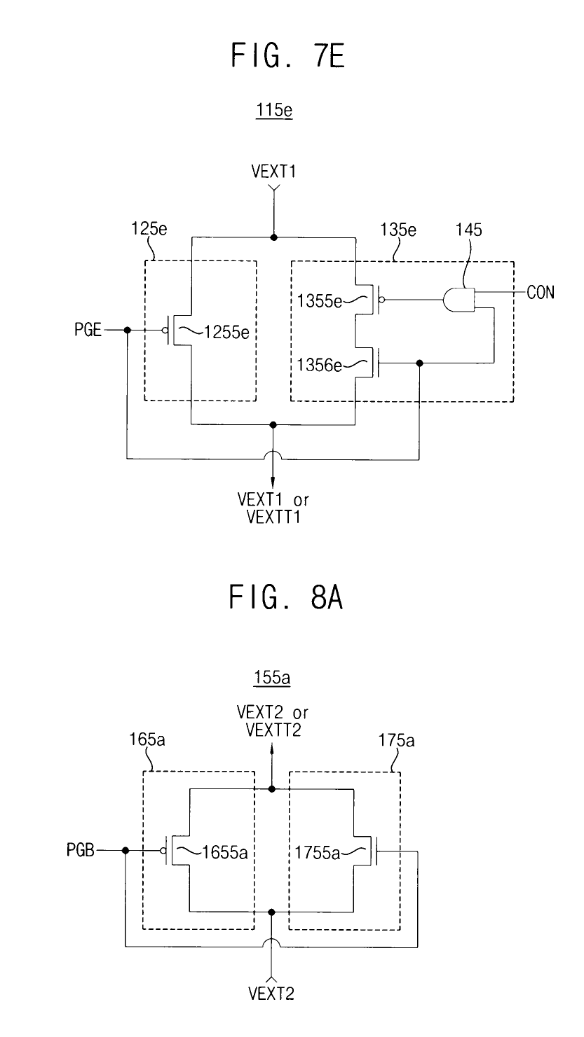

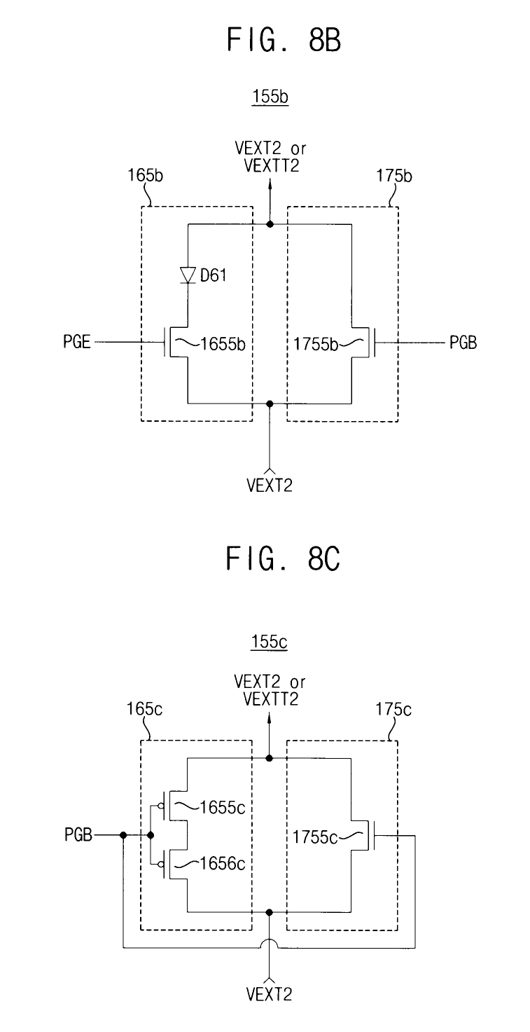

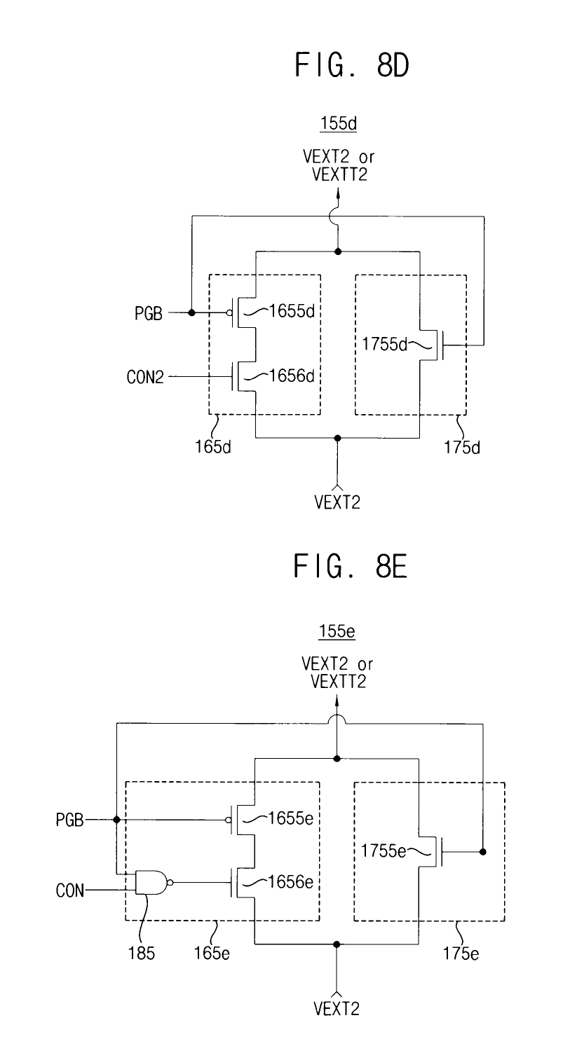

The power gating circuit 100 entirely applies the first power supply voltage VEXT to the logic circuit 200 based on the power gating signal PG in the normal operation mode, and partially applies the second power supply voltage VEXTT to the logic circuit 200 based on the power gating signal PG in the stand-by mode. The power gating signal PG may include a stand-by mode enable signal PGE, and may further include a stand-by mode disable signal PGB (e.g., a wake-up signal) that is an inversion signal of the stand-by mode enable signal PGE. The power gating circuit 100 may generate the second power supply voltage VEXTT based on the first power supply voltage VEXT and at least one of the stand-by mode enable signal PGE and the stand-by mode disable signal PGB, and further based on a gating control signal CON. Example embodiments of the power gating circuit 100 will be explained in detail with reference to FIGS. 7A, 7B, 7C, 7D, 7E, 8A, 8B, 8C, 8D and 8E.

In an example embodiment, the logic circuit 200 may be divided into an active region and an inactive region. Both of the active region and the inactive region of the logic circuit may be activated (or enabled) by the first power supply voltage VEXT in the normal operation mode. The active region of the logic circuit 200 may be activated by the second power supply voltage VEXTT to maintain the voltage level of the output signal VOUT in the stand-by mode. The inactive region of the logic circuit 200 may be deactivated (or disabled) in the stand-by mode. The active region of the logic circuit 200 may include at least one transistor (e.g., p-type or n-type transistor) that is maintained to be turned on in the stand-by mode, and the inactive region of the logic circuit 200 may include at least one transistor that is turned off in the stand-by mode.

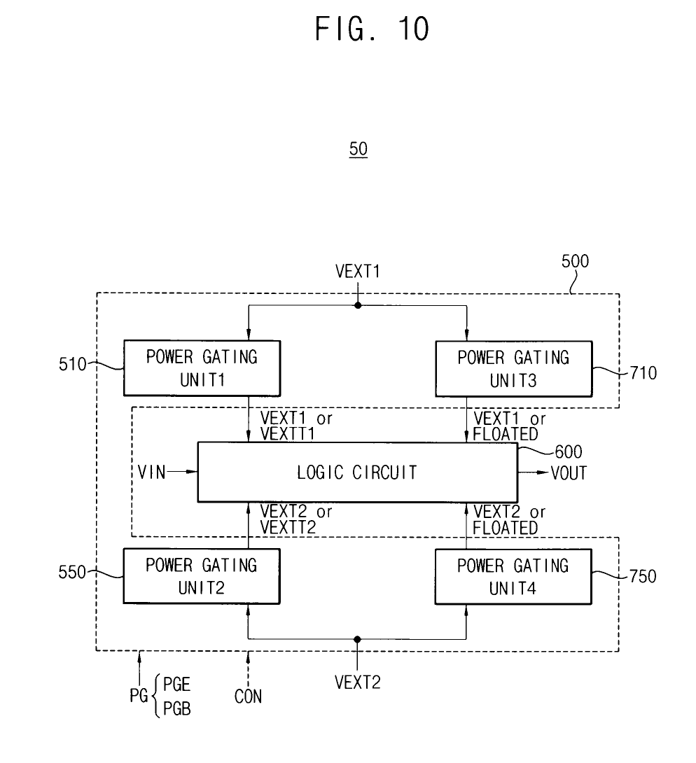

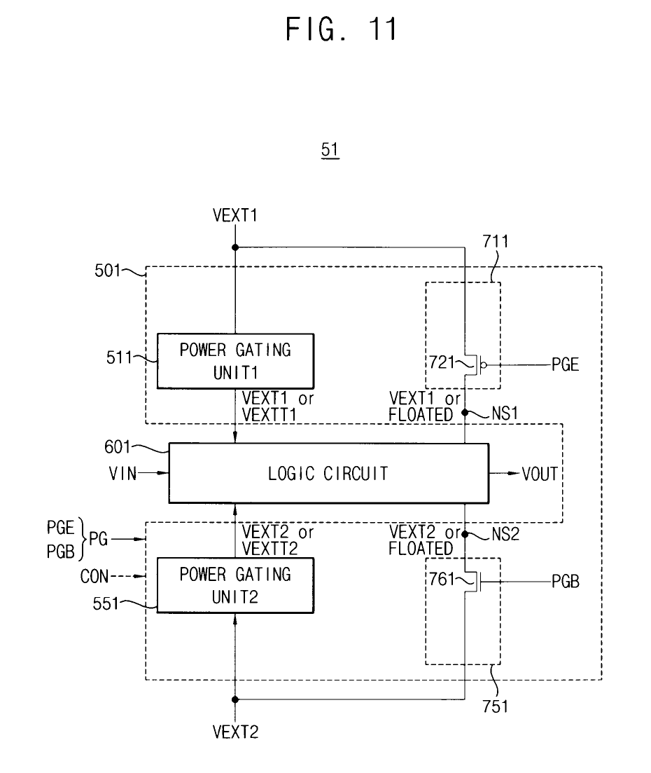

In an example embodiment, the power gating circuit 100 may electrically isolate the inactive region of the logic circuit 200 from the first power supply voltage VEXT in the stand-by mode. Other example embodiments of the power gating circuit 100 will be explained in detail with reference to FIGS. 10, 11, 12, 13 and 14.

As integrated circuits become more highly integrated, the size of transistors such as metal oxide semiconductor field effect transistors (MOSFETs) included in the integrated circuits has decreased. In MOSFETs, a short channel effect may occur if the size of the MOSFET is decreased, or in other words as a channel length of the MOSFET is decreased. A leakage current (e.g., a gate leakage current) may increase due to the short channel effect, thereby increasing power consumption. To reduce power consumption in integrated circuits, it is required to decrease leakage current in the stand-by mode.

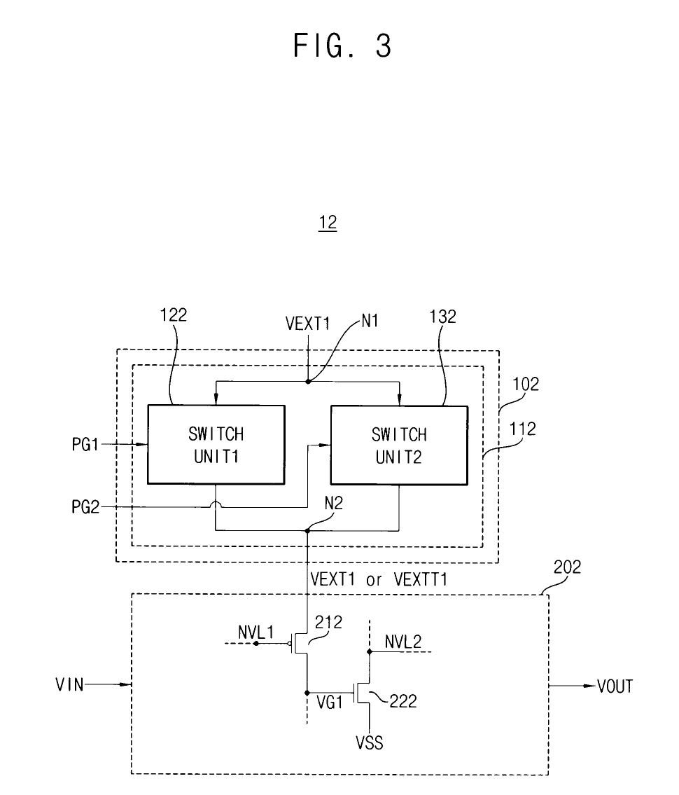

In the integrated circuit 10 according to some example embodiments, the power gating circuit 100 partially applies the second power supply voltage VEXTT instead of the first power supply voltage VEXT to the active region of the logic circuit 200 in the stand-by mode. The magnitude of the second power supply voltage VEXTT is smaller than the magnitude of the first power supply voltage VEXT. As will be described with reference to FIGS. 3, 4 and 6, a gate electrode of the MOSFET included in the active region of the logic circuit 200 may receive a relatively low gate voltage due to the second power supply voltage VEXTT. Thus, the integrated circuit 10 may have relatively low power consumption in the stand-by mode, and may effectively retain an output data (e.g., the output signal VOUT) of the logic circuit 200 in the stand-by mode.

FIG. 2 is a block diagram illustrating an example of the integrated circuit of FIG. 1.

Referring to FIG. 2, an integrated circuit 11 includes a power gating circuit 101 and a logic circuit 201. The power gating circuit 101 may include a power gating unit 111. The first power supply voltage VEXT may include a first positive power supply voltage VEXT1 and a first negative power supply voltage VEXT2. The second power supply voltage VEXTT may include a second positive power supply voltage VEXTT1 and a second negative power supply voltage VEXTT2. The first and second positive power supply voltages VEXT1 and VEXTT1 may be positive voltages, and the first and second negative power supply voltages VEXT2 and VEXTT2 may be negative voltages, respectively.

In an example embodiment, as will be described below with reference to FIG. 3, the power gating unit 111 may apply the second positive power supply voltage VEXTT1 instead of the first positive power supply voltage VEXT1 to the logic circuit 200 based on the power gating signal PG in the stand-by mode. In this case, as will be described below with reference to FIGS. 10, 11, 12, 13 and 14, the power gating unit 111 may further electrically isolate the logic circuit 200 from the first negative power supply voltage VEXT2 in the stand-by mode.

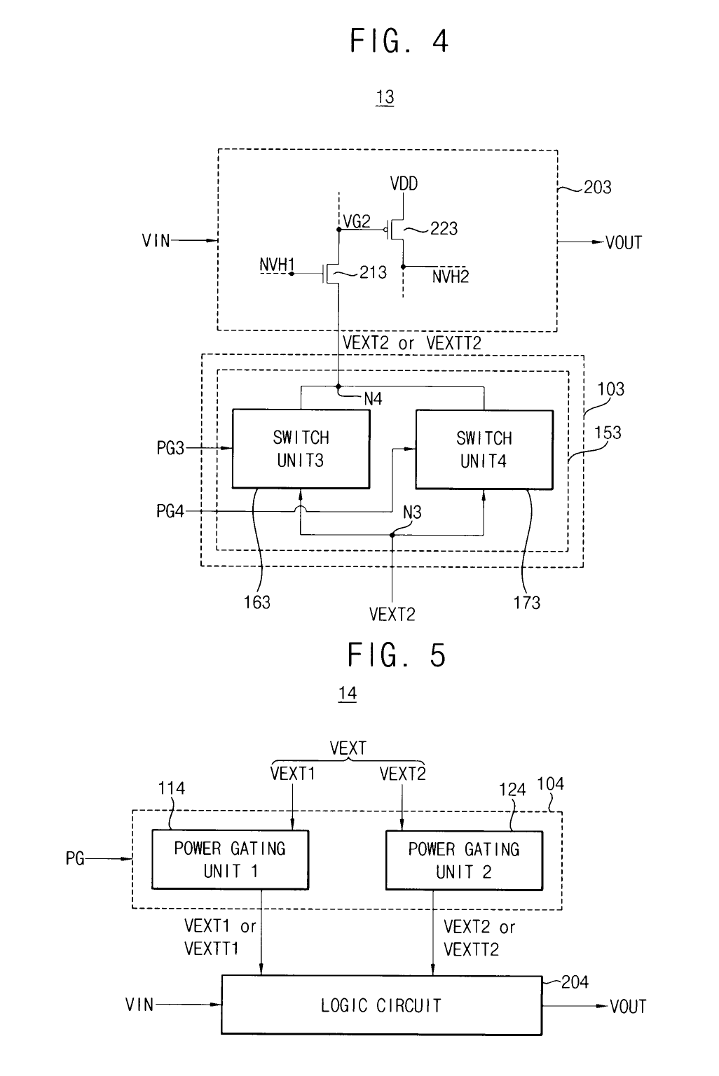

In another example embodiment, as will be described below with reference to FIG. 4, the power gating unit 111 may apply the second negative power supply voltage VEXTT2 instead of the first negative power supply voltage VEXT2 to the logic circuit 200 based on the power gating signal PG in the stand-by mode. In this case, as will be described below with reference to FIGS. 10, 11, 12, 13 and 14, the power gating unit 111 may further electrically isolate the logic circuit 200 from the first positive power supply voltage VEXT1 in the stand-by mode.

FIGS. 3 and 4 diagrams illustrating examples of the integrated circuit of FIG. 2.

Referring to FIG. 3, an integrated circuit 12 includes a power gating circuit 102 and a logic circuit 202. The power gating circuit 102 may include a first power gating unit 112. The first power gating unit 112 may include a first switch unit 122 and a second switch unit 132. The power gating signal PG may include a first power gating signal PG1 and a second power gating signal PG2.

The first switch unit 122 may selectively connect the first positive power supply voltage VEXT1 with the logic circuit 202 based on the first power gating signal PG1. In the stand-by mode, when the first power gating signal PG1 is activated (e.g., when the first power gating signal PG1 has a logic high level), the first switch unit 122 may electrically disconnect (i.e., be opened) a first node N1 with a second node N2. In the normal operation mode, when the first power gating signal PG1 is deactivated (e.g., when the first power gating signal PG1 has a logic low level), the first switch unit 122 may electrically connect (i.e., be shorted) the first node N1 with the second node N2 to provide the first positive power supply voltage VEXT1 to all regions of the logic circuit 202. The logic high level may correspond to a level of the first positive power supply voltage VEXT1, and the logic low level may correspond to a level of the first negative power supply voltage VEXT2.

The second switch unit 132 may selectively connect the first node N1 with the second node N2 based on the second power gating signal PG2. In the normal operation mode, when the second power gating signal PG2 is deactivated (e.g., when the second power gating signal PG2 has the logic low level), the second switch unit 132 may electrically disconnect (i.e., be opened) the first node N1 with the second node N2. In the stand-by mode, when the second power gating signal PG2 is activated (e.g., when the second power gating signal PG2 has the logic high level) the second switch unit 132 may electrically connect (i.e., be shorted) the first node N1 with the second node N2, may generate the second positive power supply voltage VEXTT1 by decreasing a magnitude of the first positive power supply voltage VEXT1 to provide the second positive power supply voltage VEXTT1 to the active region of the logic circuit 202. For example, the second switch unit 132 may reduce a level of the first positive power supply voltage VEXT1 by a drop voltage level to generate the second positive power supply voltage VEXTT1 in the stand-by mode.

As illustrated in FIGS. 7A, 7B, 7C, 7D and 7E, the first power gating signal PG1 may be the stand-by mode enable signal PGE. As illustrated in FIGS. 7A and 7C, the second power gating signal PG2 may be the stand-by mode enable signal PGE. Alternatively, as illustrated in FIG. 7B, the second power gating signal PG2 may be the stand-by mode disable signal PGB.

The logic circuit 202 may include at least one p-type transistor 212 and at least one n-type transistor 222. For convenience of illustration, the logic circuit 202 having one p-type transistor and one n-type transistor is illustrated in FIG. 3, although the number of transistors included in the logic circuit 202 is not limited thereto.

In the stand-by mode, if a gate electrode NVL1 of the p-type transistor 212 may be maintained at the logic low level, the p-type transistor 212 may be maintained to be turned on. A source electrode of the p-type transistor 212 may receive the second positive power supply voltage VEXTT1 from the power gating circuit 102. A drain electrode of the p-type transistor 212 may have a first gate voltage VG1 corresponding to the second positive power supply voltage VEXTT1 since the p-type transistor 212 is turned on. The n-type transistor 222 may have a gate electrode that is connected to the drain electrode of the p-type transistor 212. The gate electrode of the n-type transistor 222 may receive the first gate voltage VG1 from the drain electrode of the p-type transistor 212, a level of the first gate voltage VG1 may correspond to a level of the second positive power supply voltage VEXTT1 (e.g., the logic high level), and thus the n-type transistor 222 may be maintained to be turned on in the stand-by mode. However, since the level of the second positive power supply voltage VEXTT1 is lower than a level of the first positive power supply voltage VEXT1, in other words, the magnitude of the second positive power supply voltage VEXTT1 is smaller than the magnitude of the first positive power supply voltage VEXT1, the level of the first gate voltage VG1 may be lower than a voltage level at the gate electrode of the n-type transistor 222 in the normal operation mode. Thus, in the stand-by mode, the voltage difference between the gate electrode of the turned-on n-type transistor 222 and a substrate including the n-type transistor 222 may be reduced, and a leakage current (e.g., a gate leakage current) of the n-type transistor 222 may be reduced.

A source electrode of the n-type transistor 222 may receive a negative voltage VSS in the stand-by mode. A drain electrode NVL2 of the n-type transistor 222 may have a voltage corresponding to the negative voltage VSS since the n-type transistor 222 is turned on in the stand-by mode. The negative voltage VSS may be one of the first negative power supply voltage VEXT2 and the second negative power supply voltage VEXTT2, according to some example embodiments.

In the integrated circuit 12 of FIG. 3, the power gating circuit 102 may apply the first gate voltage VG1 having relatively low voltage level (i.e., having relatively small magnitude) to the n-type transistor 222 included in the active region of the logic circuit 202 based on the second positive power supply voltage VEXTT1 in the stand-by mode. Thus, in the stand-by mode, the leakage current of the n-type transistor 222 may be reduced, and the integrated circuit 12 may have relatively low power consumption.

Referring to FIG. 4, an integrated circuit 13 includes a power gating circuit 103 and a logic circuit 203. The power gating circuit 103 may include a second power gating unit 153. The second power gating unit 153 may include a third switch unit 163 and a fourth switch unit 173. The power gating signal PG may include a third power gating signal PG3 and a fourth power gating signal PG4.

The third switch unit 163 may selectively connect a third node N3 with a fourth node N4 based on the third power gating signal PG3. In the normal operation mode, when the third power gating signal PG3 is activated (e.g., when the third power gating signal PG3 has the logic high level), the third switch unit 163 may electrically disconnect (i.e., be opened) the third node N3 with the fourth node N4. In the stand-by mode, when the third power gating signal PG3 is deactivated (e.g., when the third power gating signal PG3 has the logic low level), the third switch unit 163 may electrically connect (i.e., be shorted) the third node N3 with the fourth node N4, may generate the second negative power supply voltage VEXTT2 by decreasing a magnitude of the first negative power supply voltage VEXT2 to provide the second negative power supply voltage VEXTT2 to the active region of the logic circuit 203. For example, the third switch unit 163 may increase a level of the first negative power supply voltage VEXT2 by the drop voltage level to generate the second negative power supply voltage VEXTT2 in the stand-by mode.

The fourth switch unit 173 may selectively connect the first negative power supply voltage VEXT2 with the logic circuit 203 based on the fourth power gating signal PG4. In the stand-by mode, when the fourth power gating signal PG4 is deactivated (e.g., when the fourth power gating signal PG4 has the logic high low), the fourth switch unit 173 may electrically disconnect (i.e., be opened) the third node N3 with the fourth node N4. In the normal operation mode, when the fourth power gating signal PG4 is activated (e.g., when the fourth power gating signal PG4 has the logic high level), the fourth switch unit 173 may electrically connect (i.e., be shorted) the third node N3 with the fourth node N4 to provide first negative power supply voltage VEXT2 to all regions of the logic circuit 203.

As illustrated in FIGS. 8A and 8C, the third power gating signal PG3 may be the stand-by mode disable signal PGB. Alternatively, as illustrated in FIG. 8B, the third power gating signal PG3 may be the stand-by mode enable signal PGE. As illustrated in FIGS. 8A, 8B, 8C, 8D and 8E, the fourth power gating signal PG4 may be the stand-by mode disable signal PGB.

The logic circuit 203 may include at least one n-type transistor 213 and at least one p-type transistor 223. For convenience of illustration, the logic circuit 203 having one n-type transistor and one p-type transistor is illustrated in FIG. 4, although the number of transistors included in the logic circuit 203 is not limited thereto.

In the stand-by mode, if a gate electrode NVH1 of the n-type transistor 213 may be maintained at the logic high level, the n-type transistor 213 may be maintained to be turned on. A source electrode of the n-type transistor 213 may receive the second negative power supply voltage VEXTT2 from the power gating circuit 103. A drain electrode of the n-type transistor 213 may have a second gate voltage VG2 corresponding to the second negative power supply voltage VEXTT2 since the n-type transistor 213 is turned on. The p-type transistor 223 may have a gate electrode that is connected to the drain electrode of the n-type transistor 213. The gate electrode of the p-type transistor 223 may receive the second gate voltage VG2 from the drain electrode of the n-type transistor 213, a level of the second gate voltage VG2 may correspond to a level of the second negative power supply voltage VEXTT2 (e.g., the logic low level), and thus the p-type transistor 223 may be maintained to be turned on in the stand-by mode. However, since the level of the second negative power supply voltage VEXTT2 is higher than a level of the first negative power supply voltage VEXT2, in other words, the magnitude of the second negative power supply voltage VEXTT2 is smaller than the magnitude of the first negative power supply voltage VEXT2, the level of the second gate voltage VG2 may be higher than a voltage level at the gate electrode of the p-type transistor 223 in the normal operation mode (i.e., a magnitude of the second gate voltage VG2 may be smaller than a magnitude of a voltage at the gate electrode of the p-type transistor 223 in the normal operation mode). Thus, in the stand-by mode, voltage difference between the gate electrode of the turned-on p-type transistor 223 and a substrate including the p-type transistor 223 may be reduced, and a leakage current (e.g., a gate leakage current) of the p-type transistor 223 may be reduced.

A source electrode of the p-type transistor 223 may receive a positive voltage VDD in the stand-by mode. A drain electrode NVH2 of the p-type transistor 223 may have a voltage corresponding to the positive voltage VDD since the p-type transistor 223 is turned on in the stand-by mode. The positive voltage VDD may be one of the first positive power supply voltage VEXT1 and the second positive power supply voltage VEXTT1, according to some example embodiments.

In the integrated circuit 13 of FIG. 4, the power gating circuit 103 may apply the second gate voltage VG2 having relatively high voltage level (i.e. having relatively small magnitude) to the p-type transistor 223 included in the active region of the logic circuit 203 based on the second negative power supply voltage VEXTT2 in the stand-by mode. Thus, in the stand-by mode, the leakage current of the p-type transistor 223 may be reduced, and the integrated circuit 13 may have relatively low power consumption.

FIG. 5 is a block diagram illustrating another example of the integrated circuit of FIG. 1.

Referring to FIG. 5, an integrated circuit 14 includes a power gating circuit 104 and a logic circuit 204. The power gating circuit 104 may include both of a first power gating unit 114 and a second power gating unit 124. The first power supply voltage VEXT may include a first positive power supply voltage VEXT1 and a first negative power supply voltage VEXT2. The second power supply voltage VEXTT may include a second positive power supply voltage VEXTT1 and a second negative power supply voltage VEXTT2.

The power gating circuit 104 may generate the second positive power supply voltage VEXTT1 by decreasing a magnitude of the first positive power supply voltage VEXT1 to provide the second positive power supply voltage VEXTT1 to the active region of the logic circuit 204 in the stand-by mode. In addition, the power gating circuit 104 may generate the second negative power supply voltage VEXTT2 by decreasing a magnitude of the first negative power supply voltage VEXT2 to provide the second negative power supply voltage VEXTT2 to the active region of the logic circuit 204 in the stand-by mode. The power gating circuit 104 may electrically isolate another region (e.g., the inactive region) of the logic circuit 204 from the first positive power supply voltage VEXT1 and the first negative power supply voltage VEXT2 in the stand-by mode, according to some example embodiments.

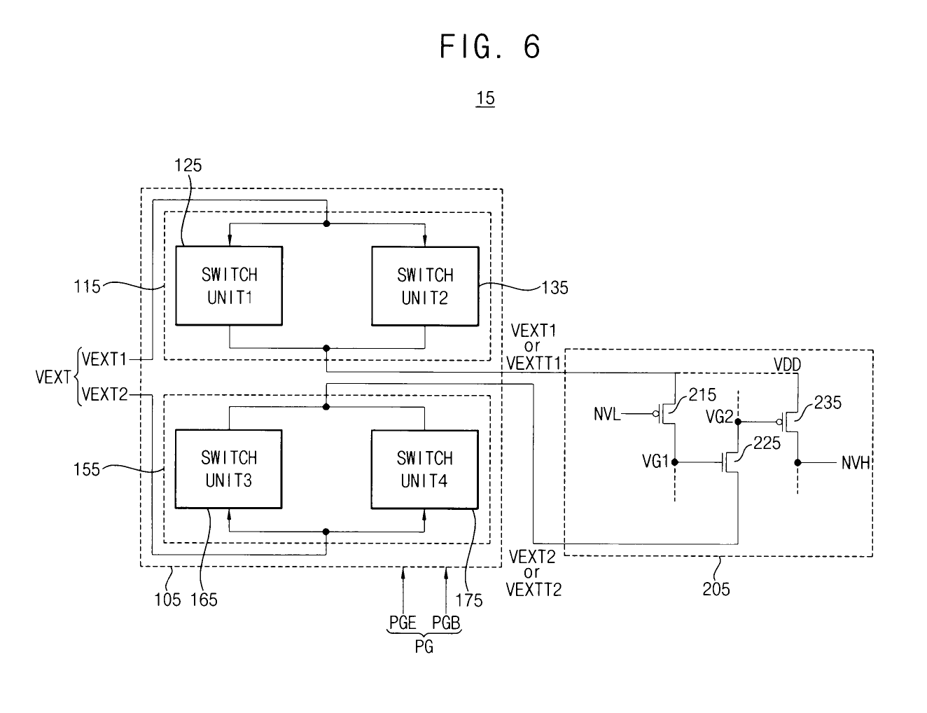

FIG. 6 is a diagram illustrating an example of the integrated circuit of FIG. 5.

Referring to FIG. 6, an integrated circuit 15 includes a power gating circuit 105 and a logic circuit 205. The power gating circuit 105 may include a first power gating unit 115 and a second power gating unit 155. The first power gating unit 115 may include a first switch unit 125 and a second switch unit 135. The second power gating unit 155 may include a third switch unit 165 and a fourth switch unit 175. Each switch unit may be controlled based on the power gating signal PG. For example, the first, second, third and fourth switch units 125, 135, 165 and 175 may be controlled by at least one of the stand-by mode enable signal PGE and the stand-by mode disable signal PGB, respectively.

In comparison with the integrated circuit 12 of FIG. 3 and the integrated circuit 13 of FIG. 4, the integrated circuit 15 may include the power gating circuit 105 that has both of the first power gating unit 115 and the second power gating unit 155. The first power gating unit 115 may be substantially the same as the first power gating unit 112 in FIG. 3, and the second power gating unit 155 may be substantially the same as the second power gating unit 153 in FIG. 4.

The logic circuit 205 may include at least one p-type transistor 215 and 235 and at least one n-type transistor 225. For convenience of illustration, the logic circuit 205 having two p-type transistors and one n-type transistor is illustrated in FIG. 6, although the number of transistors included in the logic circuit 205 is not limited thereto.

In the stand-by mode, if a gate electrode NVL of the p-type transistor 215 may be maintained at the logic low level, the p-type transistor 215 may be maintained to be turned on. A source electrode of the p-type transistor 215 may receive the second positive power supply voltage VEXTT1 from the power gating circuit 105. A drain electrode of the p-type transistor 215 may have a first gate voltage VG1 corresponding to the second positive power supply voltage VEXTT1 since the p-type transistor 215 is turned on. The n-type transistor 225 may have a gate electrode that is connected to the drain electrode of the p-type transistor 215. The gate electrode of the n-type transistor 225 may receive the first gate voltage VG1 from the drain electrode of the p-type transistor 215, a level of the first gate voltage VG1 may correspond to a level of the second positive power supply voltage VEXTT1 (e.g., the logic high level), and thus the n-type transistor 225 may be maintained to be turned on in the stand-by mode. A source electrode of the n-type transistor 225 may receive the second negative power supply voltage VEXTT2 from the power gating circuit 105. A drain electrode of the n-type transistor 225 may have a second gate voltage VG2 corresponding to the second negative power supply voltage VEXTT2 since the n-type transistor 225 is turned on. The p-type transistor 235 may have a gate electrode that is connected to the drain electrode of the n-type transistor 225. The gate electrode of the p-type transistor 235 may receive the second gate voltage VG2 from the drain electrode of the n-type transistor 225, a level of the second gate voltage VG2 may correspond to a level of the second negative power supply voltage VEXTT2 (e.g., the logic low level), and thus the p-type transistor 235 may be maintained to be turned on in the stand-by mode. A drain electrode NVH of the p-type transistor 235 may have a voltage corresponding to the positive voltage VDD (e.g., one of the first positive power supply voltage VEXT1 and the second positive power supply voltage VEXTT1).

In the stand-by mode, the p-type transistor 215 may receive the second positive power supply voltage VEXTT1 having a smaller magnitude than the magnitude of the first positive power supply voltage VEXT1, rather than having the first positive power supply voltage VEXT1 shut off. The n-type transistor 225 may receive the second negative power supply voltage VEXTT2 having a smaller magnitude than the magnitude of the first negative power supply voltage VEXT2, rather than having the first negative power supply voltage VEXT2 shut off. Thus, the n-type transistors 225 and the p-type transistor 235 may be activated (i.e., turned on) to maintain the voltage level of the output signal VOUT in the stand-by mode.

In addition, as described above with reference to FIGS. 3 and 4, the level of the first gate voltage VG1 may be lower than a voltage level at the gate electrode of the n-type transistor 225 in the normal operation mode, and the level of the second gate voltage VG2 may be higher than a voltage level at the gate electrode of the p-type transistor 235 in the normal operation mode. Thus, in the stand-by mode, the voltage difference between the gate electrode of the turned-on n-type transistor 225 and a substrate may be reduced, and the voltage difference between the gate electrode of the turned-on p-type transistor 235 and the substrate may be reduced, in the case that the substrate includes the n-type transistor 225 and the p-type transistor 235. A leakage current of the n-type transistor 225 and a leakage current of the p-type transistor 235 may be reduced, and thus the integrated circuit 15 may have relatively low power consumption in the stand-by mode.

FIGS. 7A, 7B, 7C, 7D and 7E are circuit diagrams illustrating examples of a first power gating unit included in the integrated circuit of FIG. 1.

Referring to FIG. 7A, a first power gating unit 115a may include a first switch unit 125a and a second switch unit 135a. The first switch unit 125a may include a p-type transistor 1255a. The p-type transistor 1255a may be connected between the first positive power supply voltage VEXT1 and the logic circuit 200 in FIG. 1. The p-type transistor 1255a may have a gate electrode receiving the stand-by mode enable signal PGE. Even though the p-type transistor 1255a is turned on, the voltage difference between a source electrode and a drain electrode of the p-type transistor 1255a may be substantially the same as about zero. Thus, in the normal operation mode, when the stand-by mode enable signal PGE is deactivated, the p-type transistor 1255a may provide a voltage that is substantially the same as the first positive power supply voltage VEXT1 to the logic circuit 200 in FIG. 1.

The second switch unit 135a may include an n-type transistor 1355a. The n-type transistor 1355a may be connected in parallel with the p-type transistor 1255a. The n-type transistor 1355a may be connected between the first positive power supply voltage VEXT1 and the logic circuit 200 in FIG. 1. The n-type transistor 1355a may have a gate electrode receiving the stand-by mode enable signal PGE. If the n-type transistor 1355a is turned on, a voltage difference between a source electrode and a drain electrode of the n-type transistor 1355a may exist. For example, the voltage difference between the source electrode and the drain electrode of the n-type transistor 1355a may correspond to a threshold voltage of the n-type transistor 1355a. Thus, in the stand-by mode, when the stand-by mode enable signal PGE is activated, the n-type transistor 1355a may provide the second positive power supply voltage VEXTT1 that is generated by subtracting the voltage difference between the source electrode and the drain electrode of the n-type transistor 1355a (e.g., the threshold voltage of the n-type transistor 1355a) from the first positive power supply voltage VEXT1 to the logic circuit 200 in FIG. 1.

To reduce power consumption in a stand-by mode, a conventional integrated circuit may further include an additional circuit such as a voltage generator for generating a stand-by mode power supply voltage. However, the conventional integrated circuit including such an additional voltage generator may have relatively complex structure, and the time required to start the stand-by mode may be relatively long in the conventional integrated circuit.

The integrated circuit 10 according to some example embodiments of the inventive concept may include the first power gating unit 115a of FIG. 7A instead of an additional voltage generator. The first power gating unit 115a may have relatively simple structure, and may effectively generate the second positive power supply voltage VEXTT1 by decreasing the magnitude of the first positive power supply voltage VEXT1 based on the stand-by mode enable signal PGE. Thus, the integrated circuit 10 may have relatively low power consumption in the stand-by mode, and may effectively retain the output data of the logic circuit 200 in the stand-by mode.

In example embodiments as illustrated in FIGS. 7B and 7C, the second switch unit in the first power gating unit may further include a plurality of n-type transistors or a passive element such as at least one diode for decreasing the magnitude of the first positive power supply voltage VEXT1. In example embodiments as illustrated in FIGS. 7D and 7E, the second switch unit in the first power gating unit may be controlled further based on the gating control signal CON.

Referring to FIG. 7B, a first power gating unit 115b may include a first switch unit 125b and a second switch unit 135b. The first switch unit 125b may include a first p-type transistor 1255b. The first p-type transistor 1255b may be connected between the first positive power supply voltage VEXT1 and the logic circuit 200 in FIG. 1. The first p-type transistor 1255b may have a gate electrode receiving the stand-by mode enable signal PGE. The first p-type transistor 1255b in FIG. 7B may be substantially the same as the p-type transistor 1255a in FIG. 7A.

The second switch unit 135b may include a second p-type transistor 1355b and at least one diode D51. For convenience of illustration, the second switch unit 135b having one diode is illustrated in FIG. 7B, although the number of diodes included in the second switch unit 135b is not limited thereto.

The second p-type transistor 1355b may be connected to the first positive power supply voltage VEXT1, and may have a gate electrode receiving an inversion signal that is an inverted version of the stand-by mode enable signal PGE (i.e., the stand-by mode disable signal PGB). The diode D51 may be connected between the second p-type transistor 1355b and the logic circuit 200 in FIG. 1. Although not illustrated in FIG. 7B, if the second switch unit 135b includes a plurality of diodes, the plurality of diodes may be connected serially between the second p-type transistor 1355b and the logic circuit 200 in FIG. 1. In the stand-by mode, when the stand-by mode disable signal PGB is deactivated, the second p-type transistor 1355b may be turned on, the diode D51 may decrease the level of the first positive power supply voltage VEXT1 to generate the second positive power supply voltage VEXTT1, and thus the second switch unit 135b may provide the second positive power supply voltage VEXTT1 to the logic circuit 200 in FIG. 1. Although not illustrated in FIG. 7B, the second switch unit 135b may further include an inverter that generates the stand-by mode disable signal PGB by inverting the stand-by mode enable signal PGE.

Referring to FIG. 7C, a first power gating unit 115c may include a first switch unit 125c and a second switch unit 135c. The first switch unit 125c may include a p-type transistor 1255c. The p-type transistor 1255c in FIG. 7C may be substantially the same as the p-type transistor 1255a in FIG. 7A. The second switch unit 135c may include a plurality of n-type transistors 1355c and 1356c. For convenience of illustration, the second switch unit 135c having two n-type transistors is illustrated in FIG. 7C, although the number of n-type transistors included in the second switch unit 135c is not limited thereto.

The n-type transistors 1355c and 1356c may be connected serially between the first positive power supply voltage VEXT1 and the logic circuit 200 in FIG. 1. The serially-connected n-type transistors 1355c and 1356c may be connected in parallel with the p-type transistor 1255c. Each of the n-type transistors 1355c and 1356c may have a gate electrode receiving the stand-by mode enable signal PGE. In the stand-by mode, the second switch unit 135c may provide the second positive power supply voltage VEXTT1 that has a lower level than the level of the second positive power supply voltage VEXTT1 generated by the second switch unit 135a in FIG. 7A, since the second switch unit 135c includes more n-type transistors than the second switch unit 135a in FIG. 7A.

Referring to FIG. 7D, a first power gating unit 115d may include a first switch unit 125d and a second switch unit 135d. The first switch unit 125d may include a p-type transistor 1255d. The p-type transistor 1255d in FIG. 7D may be substantially the same as the p-type transistor 1255a in FIG. 7A. The second switch unit 135d may include a p-type transistor 1355d and at least one n-type transistor 1356d. For convenience of illustration, the second switch unit 135d having one n-type transistor is illustrated in FIG. 7D, although the number of n-type transistors included in the second switch unit 135d is not limited thereto.

The p-type transistor 1355d and the n-type transistor 1356d may be connected serially between the first positive power supply voltage VEXT1 and the logic circuit 200 in FIG. 1. The p-type transistor 1355d may have a gate electrode receiving a gating control signal CON1. The n-type transistors 1356d may have a gate electrode receiving the stand-by mode enable signal PGE. In the stand-by mode, when the stand-by mode enable signal PGE is activated and the gating control signal CON1 has the logic low level, the p-type transistor 1355d and the n-type transistor 1356d may be turned on, the n-type transistor 1356d may decrease the level of the first positive power supply voltage VEXT1 to generate the second positive power supply voltage VEXTT1, and thus the second switch unit 135d may provide the second positive power supply voltage VEXTT1 to the logic circuit 200 in FIG. 1.

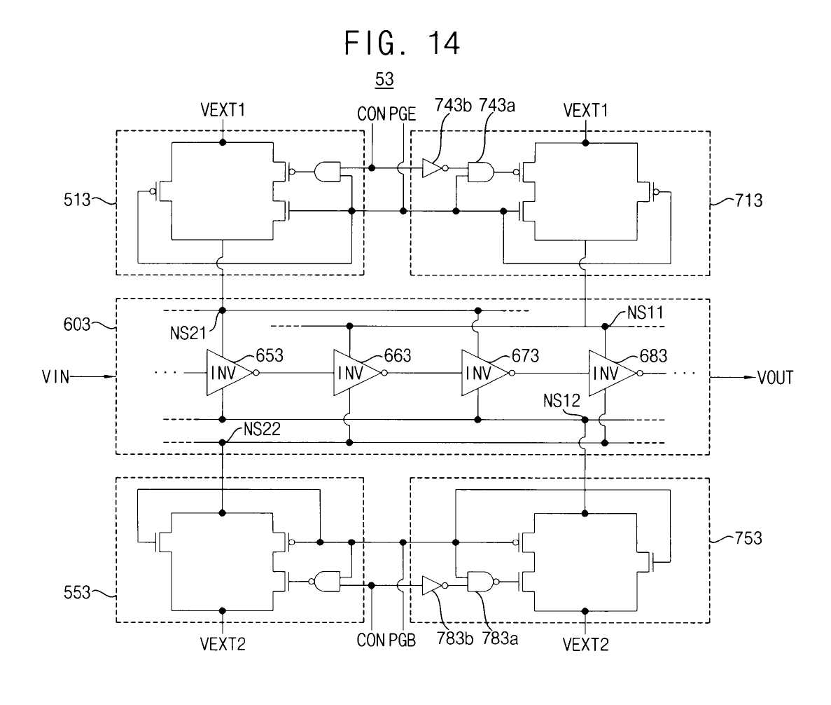

A logic level of the gating control signal CON1 may be determined depending on the output data retained by the logic circuit 200 in FIG. 1. For example, when the output signal VOUT is maintained at the logic high level, the gating control signal CON1 may correspond to the logic high level. When the output signal VOUT is maintained at the logic low level, the gating control signal CON1 may correspond to the logic low level. Example embodiments of the integrated circuit operating based on the gating control signal will be explained in detail with reference to FIG. 14.

Referring to FIG. 7E, a first power gating unit 115e may include a first switch unit 125e and a second switch unit 135e. The first switch unit 125e may include a p-type transistor 1255e. The p-type transistor 1255e in FIG. 7E may be substantially the same as the p-type transistor 1255a in FIG. 7A. The second switch unit 135e may include a p-type transistor 1355e, an AND gate 145 and at least one n-type transistor 1356e. For convenience of illustration, the second switch unit 135e having one n-type transistor is illustrated in FIG. 7E, although the number of n-type transistors included in the second switch unit 135e is not limited thereto.

In comparison with the second switch unit 135d in FIG. 7D, the second switch unit 135e may further include the AND gate 145. The AND gate 145 may perform an AND operation on the gating control signal CON and the stand-by mode enable signal PGE. The p-type transistor 1355e may have a gate electrode receiving an output signal of the AND gate 145. Example embodiments of the integrated circuit operating based on the gating control signal CON will be explained in detail with reference to FIG. 14.

FIGS. 8A, 8B, 8C, 8D and 8E are circuit diagrams illustrating examples of a second power gating unit included in the integrated circuit of FIG. 1.

Referring to FIG. 8A, a second power gating unit 155a may include a third switch unit 165a and a fourth switch unit 175a. The third switch unit 165a may include a p-type transistor 1655a. The p-type transistor 1655a may be connected between the first negative power supply voltage VEXT2 and the logic circuit 200 in FIG. 1. The p-type transistor 1655a may have a gate electrode receiving the stand-by mode disable signal PGB. If the p-type transistor 1655a is turned on, a voltage difference between a source electrode and a drain electrode of the p-type transistor 1655a may exist. For example, the voltage difference between the source electrode and the drain electrode of the p-type transistor 1655a may correspond to a threshold voltage of the p-type transistor 1655a. Thus, in the stand-by mode, when the stand-by mode disable signal PGB is deactivated, the p-type transistor 1655a may provide the second negative power supply voltage VEXTT2 that is generated by adding the voltage difference between the source electrode and the drain electrode of the p-type transistor 1655a (e.g., the threshold voltage of the p-type transistor 1655a) to the first negative power supply voltage VEXT2 to the logic circuit 200 in FIG. 1.

The fourth switch unit 175a may include an n-type transistor 1755a. The n-type transistor 1755a may be connected in parallel with the p-type transistor 1655a. The n-type transistor 1755a may be connected between the first negative power supply voltage VEXT2 and the logic circuit 200 in FIG. 1. The n-type transistor 1755a may have a gate electrode receiving the stand-by mode disable signal PGB. Even though the n-type transistor 1755a is turned on, a voltage difference between a source electrode and a drain electrode of the n-type transistor 1755a may be substantially the same as about zero. Thus, in the normal operation mode, when the stand-by mode disable signal PGE is activated, the n-type transistor 1755a may provide a voltage that is substantially the same as the first negative power supply voltage VEXT2 to the logic circuit 200 in FIG. 1.

In example embodiments as illustrated in FIGS. 8B and 8C, the third switch unit in the second power gating unit may further include a plurality of p-type transistors or a passive element such as at least one diode for decreasing the magnitude of the first negative power supply voltage VEXT2. In other example embodiments as illustrated in FIGS. 8D and 8E, the third switch unit in the second power gating unit may be controlled further based on the gating control signal CON.

Referring to FIG. 8B, a second power gating unit 155b may include a third switch unit 165b and a fourth switch unit 175b. The third switch unit 165b may include a first n-type transistor 1655b and at least one diode D61. For convenience of illustration, the third switch unit 165b having one diode D61 is illustrated in FIG. 8B, although the number of diodes included in the third switch unit 165b is not limited thereto.

The first n-type transistor 1655b may be connected to the first negative power supply voltage VEXT2, and may have a gate electrode receiving the stand-by mode enable signal PGE. The diode D61 may be connected between the first n-type transistor 1655b and the logic circuit 200 in FIG. 1. Although not illustrated in FIG. 8B, if the third switch unit 165b includes a plurality of diodes, the plurality of diodes may be connected serially between the first n-type transistor 1655b and the logic circuit 200 in FIG. 1. In the stand-by mode, when the stand-by mode enable signal PGE is activated, the first n-type transistor 1655b may be turned on, the diode D61 may increase the level of the first negative power supply voltage VEXT2 to generate the second negative power supply voltage VEXTT2, and thus the third switch unit 165b may provide the second negative power supply voltage VEXTT2 to the logic circuit 200 in FIG. 1.

The fourth switch unit 175b may include a second n-type transistor 1755b. The second n-type transistor 1755b may be connected between the first negative power supply voltage VEXT2 and the logic circuit 200 in FIG. 1. The second n-type transistor 1755b may have a gate electrode receiving the stand-by mode disable signal PGB. The n-type transistor 1755b in FIG. 8B may be substantially the same as the n-type transistor 1755a in FIG. 8A.

Referring to FIG. 8C, a second power gating unit 155c may include a third switch unit 165c and a fourth switch unit 175c. The third switch unit 165c may include a plurality of p-type transistors 1655c and 1656c. For convenience of illustration, the third switch unit 165c having two p-type transistors is illustrated in FIG. 8C, although the number of p-type transistors included in the third switch unit 165c is not limited thereto. The fourth switch unit 175c may include an n-type transistor 1755c. The n-type transistor 1755c in FIG. 8C may be substantially the same as the n-type transistor 1755a in FIG. 8A.

The p-type transistors 1655c and 1656c may be connected serially between the first negative power supply voltage VEXT2 and the logic circuit 200 in FIG. 1. The serially-connected p-type transistors 1655c and 1656c may be connected in parallel with the n-type transistor 1755c. Each of the p-type transistors 1655c and 1656c may have a gate electrode receiving the stand-by mode disable signal PGB. In the stand-by mode, the third switch unit 165c may provide the second negative power supply voltage VEXTT2 that has a higher level than the level of the second negative power supply voltage VEXTT2 generated by the third switch unit 165a in FIG. 8A, since the third switch unit 165c includes more p-type transistors than the third switch unit 165a in FIG. 8A.

Referring to FIG. 8D, a second power gating unit 155d may include a third switch unit 165d and a fourth switch unit 175d. The third switch unit 165d may include at least one p-type transistor 1655d and an n-type transistor 1656d. For convenience of illustration, the third switch unit 165d having one p-type transistor is illustrated in FIG. 8D, although the number of p-type transistors included in the third switch unit 155d is not limited thereto. The fourth switch unit 175d may include an n-type transistor 1755d. The n-type transistor 1755d in FIG. 8D may be substantially the same as the n-type transistor 1755a in FIG. 8A.

The p-type transistor 1655d and the n-type transistor 1656d may be connected serially between the first negative power supply voltage VEXT2 and the logic circuit 200 in FIG. 1. The p-type transistor 1655d may have a gate electrode receiving the stand-by mode disable signal PGB. The n-type transistor 1656d may have a gate electrode receiving a gating control signal CON2. In the stand-by mode, when the stand-by mode disable signal PGB is deactivated and the gating control signal CON2 has the logic high level, the p-type transistor 1655d and the n-type transistor 1656d may be turned on, the p-type transistor 1655d may increase the level of the first negative power supply voltage VEXT2 to generate the second negative power supply voltage VEXTT2, and thus the third switch unit 165d may provide the second negative power supply voltage VEXTT2 to the logic circuit 200 in FIG. 1.

A logic level of the gating control signal CON2 may be determined depending on the output data retained by the logic circuit 200 in FIG. 1. For example, when the output signal VOUT is maintained at the logic high level, the gating control signal CON2 may correspond to the logic low level. When the output signal VOUT is maintained at the logic low level, the gating control signal CON2 may correspond to the logic high level. In other words, the logic level of the gating control signal CON2 may be complementary to that of the logic level of the gating control signal CON1. Example embodiments of the integrated circuit operating based on the gating control signal will be explained in detail with reference to FIG. 14.

Referring to FIG. 8E, a second power gating unit 155e may include a third switch unit 165e and a fourth switch unit 175e. The third switch unit 165e may include at least one p-type transistor 1655e, a NAND gate 185 and an n-type transistor 1656e. For convenience of illustration, the third switch unit 165e having one p-type transistor is illustrated in FIG. 8E, although the number of p-type transistors included in the third switch unit 165e is not limited thereto. The fourth switch unit 175e may include an n-type transistor 1755e. The n-type transistor 1755e in FIG. 8E may be substantially the same as the n-type transistor 1755a in FIG. 8A.

In comparison with the third switch unit 165d in FIG. 8D, the third switch unit 165e may further include the NAND gate 185. The NAND gate 185 may perform a NAND operation on the gating control signal CON and the stand-by mode disable signal PGB. The n-type transistor 1656e may have a gate electrode receiving an output signal of the NAND gate 185. Example embodiments of the integrated circuit operating based on the gating control signal CON will be explained in detail with reference to FIG. 14.

In example embodiments, a gate insulation layer of a transistor included in the power gating circuit 100 in FIG. 1 may be thicker than a gate insulation layer of a transistor included in the logic circuit 200 in FIG. 1. For example, a gate insulation layer of each transistor included in each of the power gating units 115a, 115b, 115c, 115d, 115e, 155a, 155b, 155c, 155d and 155e may have a larger thickness than a thickness of the gate insulation layer of the transistor included in the logic circuit 200. The gate insulation layer may be a gate oxide layer.

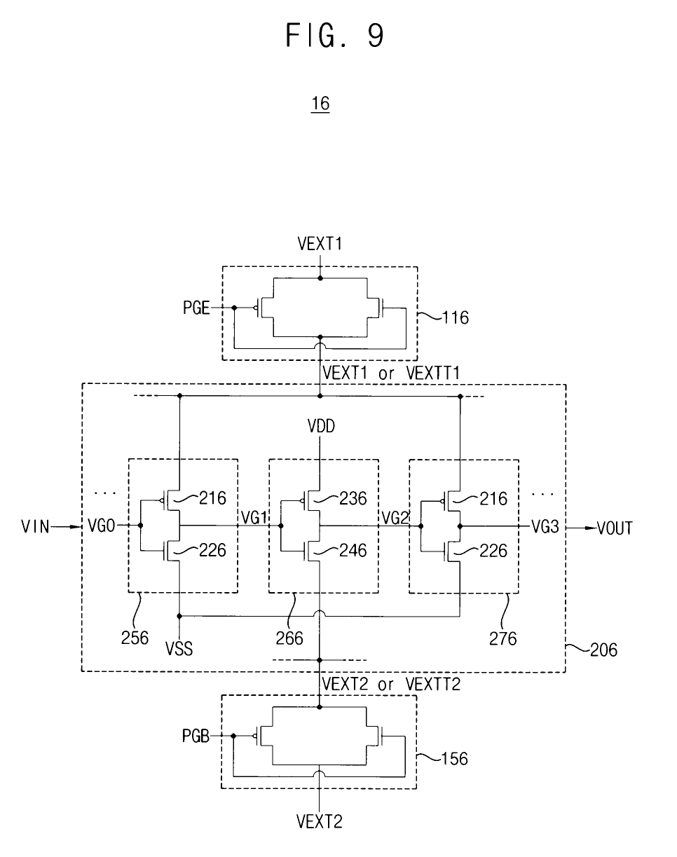

FIG. 9 is a circuit diagram illustrating another example of the integrated circuit of FIG. 5. Referring to FIG. 9, an integrated circuit 16 includes a power gating circuit and a logic circuit 206. The power gating circuit may include a first power gating unit 116 and a second power gating unit 156. The first power gating unit 116 may be one of the first power gating unit 115a of FIG. 7A, the first power gating unit 115b of FIG. 7B, the first power gating unit 115c of FIG. 7C, the first power gating unit 115d of FIG. 7D and the first power gating unit 115e of FIG. 7E. The second power gating unit 156 may be one of the second power gating unit 155a of FIG. 8A, the second power gating unit 155b of FIG. 8B, the second power gating unit 155c of FIG. 8C, the second power gating unit 155d of FIG. 8D and the second power gating unit 155e of FIG. 8E. For convenience of illustration, FIG. 9 illustrates the first power gating unit 116 that is substantially the same as the first power gating unit 115a of FIG. 7A and the second power gating unit 156 that is substantially the same as the second power gating unit 155a of FIG. 8A.

The logic circuit 206 may include an inverter chain. The inverter chain may include a plurality of inverters 256, 266 and 276 that are cascaded-coupled. For convenience of illustration, the inverter chain having three inverters is illustrated in FIG. 9, although the number of inverters included in the inverter chain is not limited thereto.

The plurality of inverters 256, 266 and 276 may be divided into first inverters 256 and 276 and second inverters 266. Each first inverter and each second inverter may be alternatively connected serially. For example, an output terminal of one first inverter 256 may be connected to an input terminal of the second inverter 266, and an output terminal of the second inverter 266 may be connected to an input terminal of another first inverter 276. An input voltage VG0 of one first inverter 256 may have a voltage level that is substantially the same as an input voltage VG2 of another first inverter 276 (i.e., an output voltage VG2 of one second inverter 266). An output voltage VG1 of one first inverter 256 may have a voltage level that is substantially the same as an output voltage VG3 of another first inverter 276.

In the normal operation mode, the power gating circuit may apply the first positive power supply voltage VEXT1 and the first negative power supply voltage VEXT2 to the first and second inverters 256, 266 and 276. The first and second inverters 256, 266 and 276 may perform logic operations based on the first positive power supply voltage VEXT1 and the first negative power supply voltage VEXT2.

In the stand-by mode, the first and second inverters 256, 266 and 276 may receive one of the second positive power supply voltage VEXTT1 and the second negative power supply voltage VEXTT2 from the power gating circuit. To maintain a voltage level of the output signal VOUT at the stand-by logic level, the output voltages of the inverters 256, 266 and 276 may be maintained at predetermined voltage levels. It is assumed that an output terminal of each first inverter is maintained at the logic high level and an output terminal of each second inverter is maintained at the logic low level in the stand-by mode.

In the stand-by mode, the first inverter 256 may receive the input voltage V0 corresponding to the logic low level. The output voltages VG1 and VG3 of the first inverters 256 and 276 may be maintained at the logic high level, and the output voltage VG2 of the second inverter 266 may be maintained at the logic low level. The first power gating unit 116 of the power gating circuit may apply the second positive power supply voltage VEXTT1 instead of the first positive power supply voltage VEXT1 to the first inverters 256 and 276. The second power gating unit 156 of the power gating circuit may apply the second negative power supply voltage VEXTT2 instead of the first negative power supply voltage VEXT2 to the second inverter 266.

Each of the first inverters 256 and 276 may include a p-type transistor 216 and an n-type transistor 226. In the stand-by mode, the p-type transistors 216 may be turned on and the n-type transistors 226 may be turned off since gate electrodes of the transistors 216 and 226 receive the voltages VG0 and VG2 having the logic low level. The second inverter 266 may include a p-type transistor 236 and an n-type transistor 246. In the stand-by mode, the p-type transistor 236 may be turned off and the n-type transistor 246 may be turned on since gate electrodes of the transistors 236 and 246 receive the voltage VG1 having the logic high level. The turned-on p-type transistors 216 and the turned-on n-type transistor 246 may correspond to the active region of the logic circuit 206, and the turned-off n-type transistors 226 and the turned-off p-type transistor 236 may correspond to the inactive region of the logic circuit 206.

In example embodiments, in the stand-by mode, the turned-off n-type transistors 226 may receive the negative voltage VSS, and the turned-off p-type transistor 236 may receive the positive voltage VDD. For example, the negative voltage VSS may be the first negative power supply voltage VEXT2, and the positive voltage VDD may be the first positive power supply voltage VEXT1.

In other example embodiments, as will be described below with reference to FIGS. 10, 11, 12, 13 and 14, in the stand-by mode, the turned-off n-type transistor 226 may be electrically isolated from the negative voltage VSS (e.g., the first negative power supply voltage VEXT2), and the turned-off p-type transistor 236 may be electrically isolated from the positive voltage VDD (e.g., the first positive power supply voltage VEXT1). For example, a source electrode of the turned-off n-type transistor 226 may be in a floating state, and a source electrode of the turned-off p-type transistor 236 may be in a floating state in the stand-by mode.

FIG. 10 is a block diagram illustrating still another example of the integrated circuit of FIG. 1. Referring to FIG. 10, an integrated circuit 50 includes a power gating circuit 500 and a logic circuit 600. The power gating circuit 500 may include a first power gating unit 510, a second power gating unit 550, a third power gating unit 710 and a fourth power gating unit 750. The logic circuit 600 may be divided into an active region being activated to maintain the voltage level of the output signal VOUT in the stand-by mode and an inactive region being deactivated in the stand-by mode.

In the normal operation mode, the power gating circuit 500 may apply the first positive power supply voltage VEXT1 to all regions of the logic circuit 600 by using the first and third power gating units 510 and 710, and may apply the first negative power supply voltage VEXT2 to all regions of the logic circuit 600 by using the second and fourth power gating units 550 and 750.

In the stand-by mode, the power gating circuit 500 may apply the second power supply voltages VEXTT1 and VEXTT2 to the active region of the logic circuit 600. The power gating circuit 500 may electrically isolate the inactive region of the logic circuit 600 from the first power supply voltages VEXT1 and VEXT2.

The active region of the logic circuit 600 may include a first active region and a second active region. The first and second active regions may include at least one transistor that is maintained to be turned on in the stand-by mode. The first active region may receive the second positive power supply voltage VEXTT1, and the second active region may receive the second negative power supply voltage VEXTT2 in the stand-by mode. In the stand-by mode, the first power gating unit 510 may apply the second positive power supply voltage VEXTT1 to the first active region, and the second power gating unit 550 may apply the second negative power supply voltage VEXTT2 to the second active region. The first and second power gating units 510 and 550 may be substantially the same as the first and second power gating units 114 and 124 in FIG. 5, respectively.

The inactive region of the logic circuit 600 may include a first inactive region and a second inactive region. The first and second inactive regions may include at least one transistor that is turned off in the stand-by mode. In the normal operation mode, the first inactive region may receive the first positive power supply voltage VEXT1, and the second inactive region may receive the first negative power supply voltage VEXT2. In the stand-by mode, the third power gating unit 710 may electrically isolate the first inactive region from the first positive power supply voltage VEXT1, and the fourth power gating unit 750 may electrically isolate the second inactive region from the first negative power supply voltage VEXT2.

In example embodiments, the active region of the logic circuit 600 may be changed to the inactive region of the logic circuit 600 depending on the stand-by logic level that is a voltage level of the output signal VOUT in the stand-by mode. The inactive region of the logic circuit 600 may be changed to the active region of the logic circuit 600 depending on the stand-by logic level. For example, a first part of the logic circuit 600 may correspond to the active region and a second part of the logic circuit may correspond to the inactive region when the voltage level of the output signal VOUT is maintained at the logic high level in the stand-by mode, and the first part of the logic circuit 600 may correspond to the inactive region and the second part of the logic circuit may correspond to the active region when the voltage level of the output signal VOUT is maintained at the logic low level in the stand-by mode.

In an ideal MOSFET, if a gate-source voltage is lower than a threshold voltage of the MOSFET, the MOSFET is turned off and charges are not transferred from a source electrode to a drain electrode of the MOSFET. However, in a real MOSFET, even though the gate-source voltage is lower than the threshold voltage of the MOSFET, some charges are transferred from a source electrode to a drain electrode of the MOSFET due to Boltzmann distribution of electron energy, which is a so-called “subthreshold leakage current.” In other words, even though the MOSFET is turned off, a leakage current may be caused by charges having relatively high energy.

In the integrated circuit 50 according to some example embodiments, the power gating circuit 500 may electrically isolate the inactive region of the logic circuit 600 from the first power supply voltages VEXT1 and VEXT2 in the stand-by mode. A source electrode of a transistor included in the inactive region of the logic circuit 600 may be in a floating state, and a leakage current (e.g., a subthreshold leakage current) of the inactive region of the logic circuit 600 may be reduced. Thus, in the stand-by mode, the integrated circuit 50 may have relatively low power consumption, and may effectively retain the output data (e.g., the output voltage VOUT) of the logic circuit 600 in the stand-by mode.

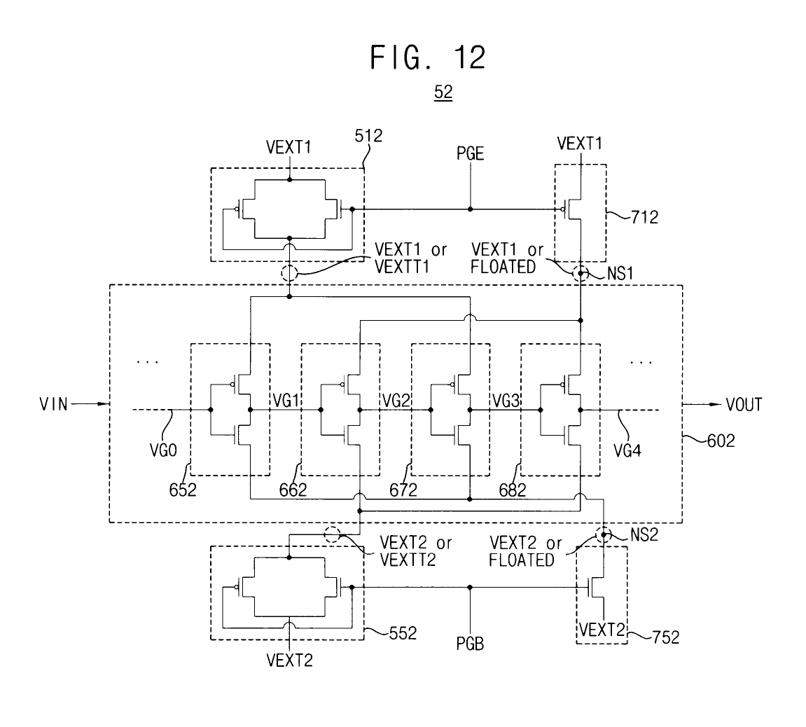

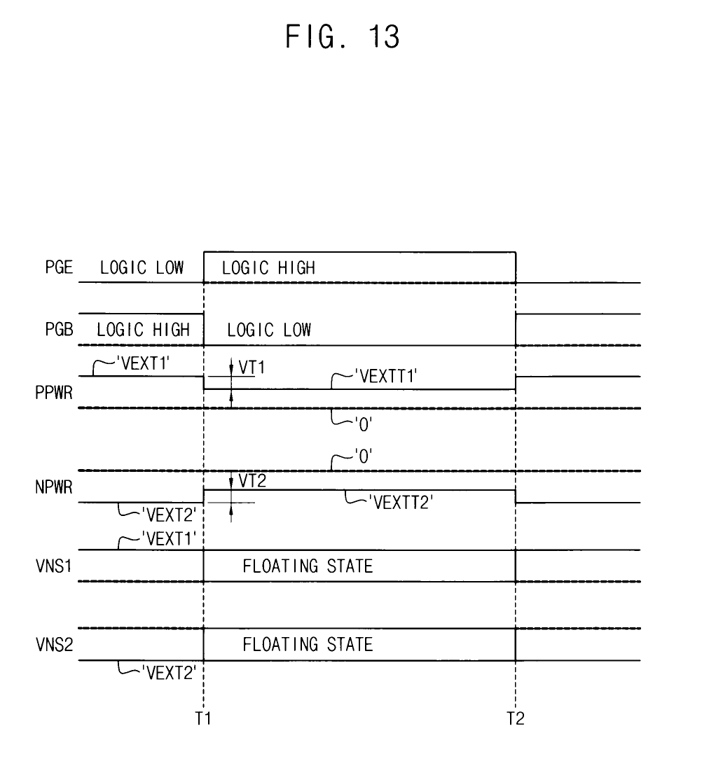

FIGS. 11 and 12 are diagrams illustrating examples of the integrated circuit of FIG. 10.

Referring to FIG. 11, an integrated circuit 51 includes a power gating circuit 501 and a logic circuit 601. The power gating circuit 501 may include a first power gating unit 511, a second power gating unit 551, a third power gating unit 711 and a fourth power gating unit 751. The first power gating unit 511, the second power gating unit 551 and the logic circuit 601 may be substantially the same as the first power gating unit 510, the second power gating unit 550 and the logic circuit 600 in FIG. 10, respectively.

The third power gating unit 711 may include a p-type transistor 721. The p-type transistor 721 may be connected between the first positive power supply voltage VEXT1 and the logic circuit 601 (e.g., a first node NS1), and may have a gate electrode receiving the stand-by mode enable signal PGE. In the stand-by mode, when the stand-by mode enable signal PGE is activated, the p-type transistor 721 may electrically disconnect the first node NS1 from the first positive power supply voltage VEXT1, and thus the first node NS1 may be in a floating state.

The fourth power gating unit 751 may include an n-type transistor 761. The n-type transistor 761 may be connected between the first negative power supply voltage VEXT2 and the logic circuit 601 (e.g., a second node NS2), and may have a gate electrode receiving the stand-by mode disable signal PGB. In the stand-by mode, when the stand-by mode disable signal PGB is deactivated, the n-type transistor 761 may electrically disconnect the second node NS2 from the first negative power supply voltage VEXT2, and thus the second node NS2 may be in a floating state.

Referring to FIG. 12, an integrated circuit 52 includes a power gating circuit and a logic circuit 602. The power gating circuit may include a first power gating unit 512, a second power gating unit 552, a third power gating unit 712 and a fourth power gating unit 752. The first power gating unit 512 and the second power gating unit 552 may be substantially the same as the first power gating unit 116 and the second power gating unit 156 in FIG. 9, respectively. The third power gating unit 712 and the fourth power gating unit 752 may be substantially the same as the third power gating unit 711 and the fourth power gating unit 751 in FIG. 11, respectively.

The logic circuit 602 may include an inverter chain. The inverter chain may include a plurality of inverters 652, 662, 672 and 682 that are cascaded-coupled. For convenience of illustration, the inverter chain having four inverters is illustrated in FIG. 12, although the number of inverters included in the inverter chain is not limited thereto. As described above with reference to FIG. 9, the plurality of inverters 652, 662, 672 and 682 may be divided into first inverters 652 and 672 and second inverters 662 and 682 depending on output voltage levels.

In the normal operation mode, the power gating circuit may apply the first positive power supply voltage VEXT1 and the first negative power supply voltage VEXT2 to the first and second inverters 652, 662, 672 and 682. In the stand-by mode, the first and second inverters 652, 662, 672 and 682 may receive one of the second positive power supply voltage VEXTT1 and the second negative power supply voltage VEXTT2 from the power gating circuit. Similarly to FIG. 9, it is assumed that an output terminal of each first inverter is maintained at the logic high level and an output terminal of each second inverter is maintained at the logic low level in the stand-by mode.

In the stand-by mode, the first inverter 652 may receive the input voltage V0 corresponding to the logic low level. The output voltages VG1 and VG3 of the first inverters 652 and 672 may be maintained at the logic high level, and the output voltages VG2 and VG4 of the second inverters 662 and 682 may be maintained at the logic low level. The first power gating unit 512 of the power gating circuit may apply the second positive power supply voltage VEXTT1 instead of the first positive power supply voltage VEXT1 to the first inverters 652 and 672. The second power gating unit 552 of the power gating circuit may apply the second negative power supply voltage VEXTT2 instead of the first negative power supply voltage VEXT2 to the second inverters 662 and 682. The third power gating unit 712 may electrically isolate the second inverters 662 and 682 from the first positive power supply voltage VEXT1. The fourth power gating unit 752 may electrically isolate the first inverters 652 and 672 from the first negative power supply voltage VEXT2.

Each of the first inverters 652 and 672 may include a p-type transistor and an n-type transistor. In the stand-by mode, the p-type transistor in each first inverter may be turned on and the n-type transistor in each first inverter may be turned off since gate electrodes of the transistors in each first inverter receive the voltages VG0 and VG2 having the logic low level. Each of the second inverters 662 and 682 may include a p-type transistor and an n-type transistor. In the stand-by mode, the p-type transistor in each second inverter may be turned off and the n-type transistor in each second inverter may be turned on since gate electrodes of the transistors in each second inverter receive the voltages VG1 and VG3 having the logic high level. The turned-on p-type transistor in each first inverter and the turned-on n-type transistor in each second inverter may correspond to the active region of the logic circuit 602, and the turned-off n-type transistor in each first inverter and the turned-off p-type transistor in each second inverter may correspond to the inactive region of the logic circuit 602.

In example embodiments, a gate insulation layer of a transistor included in the power gating units 512, 552, 712 and 752 may be thicker than a gate insulation layer of a transistor included in the logic circuit 602.

FIG. 13 is a diagram for describing an operation of the integrated circuit of FIG. 12. In FIG. 13, PPWR indicates a positive power supplied to the logic circuit 602 in the integrated circuit 52, NPWR indicates a negative power supplied to the logic circuit 602 in the integrated circuit 52, VNS1 indicates a voltage at the first node NS1, and VNS2 indicates a voltage at the second node NS2.

Referring to FIGS. 12 and 13, in the normal operation mode (e.g., before time T1), the stand-by mode enable signal PGE has the logic low level, and the stand-by mode disable signal PGB has the logic high level. The first and third power gating units 512 and 712 may provide the first positive power supply voltage VEXT1 to all regions of the logic circuit 602. The second and fourth power gating units 552 and 752 may provide the first negative power supply voltage VEXT2 to all regions of the logic circuit 602.

At time T1, the stand-by mode enable signal PGE transitions from the logic low level to the logic high level, the stand-by mode disable signal PGB transitions from the logic high level to the logic low level, and thus the integrated circuit 52 enters the stand-by mode. In the stand-by mode (e.g., from time T1 to time T2), the first power gating unit 512 generates the second positive power supply voltage VEXTT1 by reducing a level of the first positive power supply voltage VEXT1 by a first drop voltage level VT1 to provide the second positive power supply voltage VEXTT1 to the first active region of the logic circuit 602. The second power gating unit 552 generates the second negative power supply voltage VEXTT2 by increasing a level of the first negative power supply voltage VEXT2 by a second drop voltage level VT2 to provide the second negative power supply voltage VEXTT2 to the second active region of the logic circuit 602. The third power gating unit 712 electrically disconnects the first inactive region of the logic circuit 602 from the first positive power supply voltage VEXT1, and the fourth power gating unit 752 electrically disconnects the second inactive region of the logic circuit 602 from the first negative power supply voltage VEXT2. The first and second nodes NS1 and NS2 may be in floating states.

At time T2, the stand-by mode enable signal PGE transitions from the logic high level to the logic low level, the stand-by mode disable signal PGB transitions from the logic low level to the logic high level, and thus the integrated circuit 52 enters the normal operation mode.

FIG. 14 is a circuit diagram illustrating another example of the integrated circuit of FIG. 10. Referring to FIG. 14, an integrated circuit 53 includes a power gating circuit and a logic circuit 603. The power gating circuit may include a first power gating unit 513, a second power gating unit 553, a third power gating unit 713 and a fourth power gating unit 753.

The first power gating unit 513 may be substantially the same as the first power gating unit 115e of FIG. 7E. The third power gating unit 713 may be similar to the first power gating unit 513. In comparison with first power gating unit 513, the third power gating unit 713 may further include an inverter 743b that inverts the gating control signal CON to provide the inverted gating control signal to an AND gate 743a. The second power gating unit 553 may be substantially the same as the second power gating unit 155e of FIG. 8E. The fourth power gating unit 753 may be similar to the second power gating unit 553. In comparison with second power gating unit 553, the fourth power gating unit 753 may further include an inverter 783b that inverts the gating control signal CON to provide the inverted gating control signal to an NAND gate 783a. The logic circuit 603 may be substantially the same as the logic circuit 602 in FIG. 12.

In FIG. 14, an output voltage of each inverter included in the logic circuit 603 may be variable in each stand-by mode. In other words, the stand-by logic level of the output signal VOUT in the stand-by mode may be changed depending on the voltage level of the input signal VIN at a point in time at which the integrated circuit 53 enters the stand-by mode. For example, if the input signal VIN has the logic high level at the point in time at which the integrated circuit 53 enters the stand-by mode, the voltage level of the output signal VOUT may be maintained at the logic low level in the stand-by mode. If the input signal VIN has the logic low level at the point in time at which the integrated circuit 53 enters the stand-by mode, the voltage level of the output signal VOUT may be maintained at the logic high level in the stand-by mode. The voltage level of the output signal VOUT may be adaptively maintained in the stand-by mode depending on the voltage level of the input signal VIN.

Hereinafter, an adaptive power gating operation of the integrated circuit 53 in the stand-by mode according to the input signal VIN and the gating control signal CON will be described in detail with reference to FIG. 14.

In example embodiments, the input signal VIN may have the logic low level at the point in time at which the integrated circuit 53 enters the stand-by mode. In this case, assuming that the input signal VIN is applied to an inverter 653, the output voltages of first inverters 653 and 673 (e.g., odd-numbered inverters) may be maintained at the logic high level, and the output voltages of second inverters 663 and 683 (e.g., even-numbered inverters) may be maintained at the logic low level in the stand-by mode. The integrated circuit 53 may receive the gate control signal CON having the logic low level from an external device such as a controller.

A p-type transistor and an n-type transistor included in the second switch unit of the first power gating unit 513 may be turned on based on the activated stand-by mode enable signal PGE and the gate control signal CON having the logic low level. The first power gating unit 513 may provide the second positive power supply voltage VEXTT1 to the first inverters 653 and 673. Each of the first inverters 653 and 673 may have a p-type transistor that receives the second positive power supply voltage VEXTT1 and is turned on to maintain the output voltage of each first inverter at the logic high level. Similarly, a p-type transistor and an n-type transistor included in the third switch unit of the second power gating unit 553 may be turned on based on the deactivated stand-by mode disable signal PGB and the gate control signal CON having the logic low level. The second power gating unit 553 may provide the second negative power supply voltage VEXTT2 to the second inverters 663 and 683. Each of the second inverters 663 and 683 may have an n-type transistor that receives the second negative power supply voltage VEXTT2 and is turned on to maintain the output voltage of each second inverter (e.g., the voltage level of the output signal VOUT) at the logic low level.

P-type transistors included in the third power gating unit 713 may be turned off based on the activated stand-by mode enable signal PGE and the gate control signal CON having the logic low level. A first node NS11 may thus be in a floating state, and the third power gating unit 713 may electrically isolate the second inverters 663 and 683 from the first positive power supply voltage VEXT1. Similarly, n-type transistors included in the fourth power gating unit 753 may be turned off based on the deactivated stand-by mode disable signal PGB and the gate control signal CON having the logic low level. A second node NS12 may thus be in a floating state, and the fourth power gating unit 753 may electrically isolate the first inverters 653 and 673 from the first negative power supply voltage VEXT2.

In other example embodiments, the input signal VIN may have the logic high level at the point in time at which the integrated circuit 53 enters the stand-by mode. In this case, assuming that the input signal VIN is applied to the inverter 653, the output voltages of the first inverters 653 and 673 may be maintained at the logic low level, and the output voltages of the second inverters 663 and 683 may be maintained at the logic high level in the stand-by mode. The integrated circuit 53 may receive the gate control signal CON having the logic high level from the external device.

A p-type transistor and an n-type transistor included in the second switch unit of the third power gating unit 713 may be turned on based on the activated stand-by mode enable signal PGE and the gate control signal CON having the logic high level. The third power gating unit 713 may provide the second positive power supply voltage VEXTT1 to the second inverters 663 and 683. Each of the second inverters 663 and 683 may have a p-type transistor that receives the second positive power supply voltage VEXTT1 and is turned on to maintain the output voltage of each second inverter (e.g., the voltage level of the output signal VOUT) at the logic high level. Similarly, a p-type transistor and an n-type transistor included in the third switch unit of the fourth power gating unit 753 may be turned on based on the deactivated stand-by mode disable signal PGB and the gate control signal CON having the logic high level. The fourth power gating unit 753 may provide the second negative power supply voltage VEXTT2 to the first inverters 653 and 673. Each of the first inverters 653 and 673 may have an n-type transistor that receives the second negative power supply voltage VEXTT2 and is turned on to maintain the output voltage of each first inverter at the logic low level.

P-type transistors included in the first power gating unit 513 may be turned off based on the activated stand-by mode enable signal PGE and the gate control signal CON having the logic high level. A third node NS21 may thus be in a floating state, and the first power gating unit 513 may electrically isolate the first inverters 653 and 673 from the first positive power supply voltage VEXT1. Similarly, n-type transistors included in the second power gating unit 553 may be turned off based on the deactivated stand-by mode disable signal PGB and the gate control signal CON having the logic high level. A fourth node NS22 may thus be in a floating state, and the second power gating unit 553 may electrically isolate the second inverters 663 and 683 from the first negative power supply voltage VEXT2.

The gate control signal CON may correspond to at least one of the input signal VIN and the output signal VOUT. In addition, the active region and the inactive region of the logic circuit 603 may be changed with respect to each other depending on the voltage level of the input signal VIN. As described above, if the input signal VIN has the logic low level, the gate control signal CON may correspond to the logic low level, and thus the p-type transistors included in the first inverters 653 and 673 and the n-type transistors included in the second inverters 663 and 683 may be turned on. In this case, the p-type transistors included in the first inverters 653 and 673 and the n-type transistors included in the second inverters 663 and 683 may form the active region of the logic circuit 603, and the other transistors (e.g., the n-type transistors included in the first inverters 653 and 673 and the p-type transistors included in the second inverters 663 and 683) may form the inactive region of the logic circuit 603. If the input signal VIN has the logic high level, the gate control signal CON may correspond to the logic high level, and thus the n-type transistors included in the first inverters 653 and 673 and the p-type transistors included in the second inverters 663 and 683 may be turned on. In this case, the n-type transistors included in the first inverters 653 and 673 and the p-type transistors included in the second inverters 663 and 683 may form the active region of the logic circuit 603, and the other transistors (e.g., the p-type transistors included in the first inverters 653 and 673 and the n-type transistors included in the second inverters 663 and 683) may form the inactive region of the logic circuit 603.

In the integrated circuit 53 according to some example embodiments, the power gating circuit partially applies the second power supply voltages VEXTT1 and VEXTT2 instead of the first power supply voltages VEXT1 and VEXT2 to the logic circuit 603 in the stand-by mode. Thus, in the stand-by mode, a leakage current (e.g., a gate leakage current) of the turned-on transistors included in the active region of the logic circuit 603 may be reduced. The power gating circuit may electrically isolate the inactive region of the logic circuit 603 from the first power supply voltages VEXT1 and VEXT2 in the stand-by mode. Thus, in the stand-by mode, a leakage current (e.g., a subthreshold leakage current) of the turned-off transistors included in the inactive region of the logic circuit 603 may be reduced. In addition, the integrated circuit 53 may perform the adaptive power gating operation according to the input signal VIN and the gating control signal CON. Thus, the integrated circuit 53 may have relatively low power consumption in the stand-by mode, and may effectively retain an output data (e.g., the output voltage VOUT) of the logic circuit 603 in the stand-by mode.

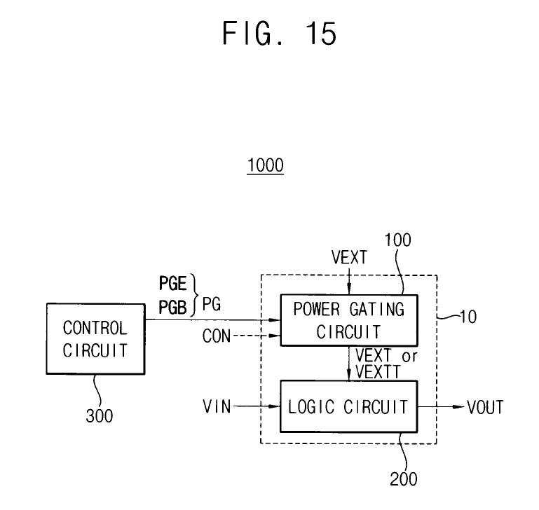

FIG. 15 is a block diagram illustrating a semiconductor device according to some example embodiments. Referring to FIG. 15, a semiconductor device 1000 includes an integrated circuit 10 and a control circuit 300.

The control circuit 300 generates a power gating signal PG. The power gating signal PG may include at least one of a stand-by mode enable signal PGE and a stand-by mode disable signal PGB. The stand-by mode enable signal PGE may be activated in a stand-by mode and may be deactivated in a normal operation mode. The stand-by mode disable signal PGB may be activated in the normal operation mode and may be deactivated in the stand-by mode. In example embodiments, the control circuit 300 may further generate a gating control signal CON.

The integrated circuit 10 has power gating function. A power consumption of the integrated circuit 10 is controlled based on the power gating signal PG. The integrated circuit 10 may be the integrated circuit 10 of FIG. 1. The integrated circuit 10 includes a power gating circuit 100 and a logic circuit 200. The logic circuit 200 generates an output signal VOUT based on an input signal VIN and a first power supply voltage VEXT in the normal operation mode, and maintains a voltage level of the output signal VOUT as a stand-by logic level based on a second power supply voltage VEXTT in the stand-by mode. The power gating circuit 100 entirely applies the first power supply voltage VEXT to the logic circuit 200 based on the power gating signal PG in the normal operation mode, and partially applies the second power supply voltage VEXTT to the logic circuit 200 based on the power gating signal PG in the stand-by mode. A magnitude of the second power supply voltage VEXTT is smaller than a magnitude of the first power supply voltage VEXT. Thus, the integrated circuit 10 may have relatively low power consumption in the stand-by mode, and may effectively retain an output data of the logic circuit 200 in the stand-by mode.

The semiconductor device 1000 may be one of various devices. For example, the semiconductor device 1000 may be a signal processing device, a communication device, a computing device, etc. Alternatively, the semiconductor device 1000 may be one of various memory devices, such as a dynamic random access memory (DRAM) device, a static random access memory (SRAM) device, a DDR synchronous DRAM (SDRAM), a graphic DDR (GDDR) SDRAM, an erasable programmable read-only memory (EPROM) device, an electrically erasable programming read-only memory (EEPROM) device, a flash memory device, etc. In this case, the integrated circuit 10 may be a row decoder circuit, a column decoder circuit, etc.

Although the integrated circuit according to some example embodiments is mainly described to include two or four power lines providing the first and second power supply voltages, the integrated circuit may include an arbitrary number of power lines. Although the power gating circuit included in the integrated circuit according to some example embodiments is mainly described with reference to FIGS. 7A, 7B, 7C, 7D, 7E, 8A, 8B, 8C, 8D and 8E, the configuration of the power gating circuit is not limited thereto. Although the logic circuit included in the integrated circuit according to some example embodiments is mainly described with reference to FIGS. 3, 4, 6, 9, 12 and 14, the configuration and the operation of the logic circuit is not limited thereto. Further, although the logic circuit included in the integrated circuit according to some example embodiments is mainly described to reduce a leakage current in the stand-by mode, the integrated circuit may reduce an arbitrary current for decreasing power consumption.

The above described embodiments may be employed in any semiconductor device or any electronic system having the semiconductor device. Thus, the present inventive concept may be applied to a system, such as a desktop computer, a laptop computer, a digital camera, a video camcorder, a cellular phone, a smart phone, a portable multimedia player (PMP), a personal digital assistant (PDA), an MP3 player, a digital television, a solid state drive (SSD), a navigation device, etc.

The foregoing is illustrative of example embodiments and is not to be construed as limiting thereof. Although a few example embodiments have been described, those skilled in the art will readily appreciate that many modifications are possible without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. An integrated circuit having power gating function, comprising:
a logic circuit configured to generate an output signal based on an input signal and a first power supply voltage in a normal operation mode, and configured to maintain a voltage level of the output signal as a stand-by logic level based on a second power supply voltage in a stand-by mode, a magnitude of the second power supply voltage being smaller than a magnitude of the first power supply voltage; and
a power gating circuit configured to entirely apply the first power supply voltage to the logic circuit based on a power gating signal in the normal operation mode, and configured to partially apply the second power supply voltage to the logic circuit based on the power gating signal in the stand-by mode.

2. The integrated circuit of claim 1, said power gating circuit comprising:
a first power gating unit configured to apply a first positive power supply voltage of the first power supply voltage to all regions of the logic circuit based on the power gating signal in the normal operation mode, and configured to apply a second positive power supply voltage of the second power supply voltage to an active region of the logic circuit based on the power gating signal in the stand-by mode, wherein the active region is a part of the logic circuit activated to maintain the voltage level of the output signal in the stand-by mode.

3. The integrated circuit of claim 2, wherein the power gating signal includes a stand-by mode enable signal, and wherein the first power gating unit comprises:
a first switch unit configured to provide the first positive power supply voltage to all regions of the logic circuit when the stand-by mode enable signal is deactivated; and
a second switch unit configured to generate the second positive power supply voltage by decreasing a magnitude of the first positive power supply voltage to provide the second positive power supply voltage to the active region of the logic circuit when the stand-by mode enable signal is activated.

4. The integrated circuit of claim 3, wherein the first switch unit includes a p-type transistor having a gate electrode receiving the stand-by mode enable signal and connected between the first positive power supply voltage and the logic circuit, and
wherein the second switch unit includes at least one n-type transistor connected serially between the first positive power supply voltage and the logic circuit, each of the at least one n-type transistor having a gate electrode receiving the stand-by mode enable signal.

5. The integrated circuit of claim 3, wherein the first switch unit includes a first p-type transistor having a gate electrode receiving the stand-by mode enable signal and connected between the first positive power supply voltage and the logic circuit, and
wherein the second switch unit includes
a second p-type transistor having a gate electrode receiving an inversion signal that is an inverted version of the stand-by mode enable signal and connected to the first positive power supply voltage; and
at least one diode connected serially between the second p-type transistor and the logic circuit.

6. The integrated circuit of claim 2, wherein the power gating circuit further comprises:
a second power gating unit configured to apply a first negative power supply voltage of the first power supply voltage to all regions of the logic circuit based on the power gating signal in the normal operation mode, and configured to apply a second negative power supply voltage of the second power supply voltage to the active region of the logic circuit based on the power gating signal in the stand-by mode.

7. The integrated circuit of claim 6, wherein the power gating signal includes a stand-by mode enable signal, and wherein the second power gating unit comprises:
a first switch unit configured to provide the first negative power supply voltage to all regions of the logic circuit when an inversion signal that is an inverted version of the stand-by mode enable signal is activated; and
a second switch unit configured to generate the second negative power supply voltage by decreasing a magnitude of the first negative power supply voltage to provide the second negative power supply voltage to the active region of the logic circuit when the inversion signal of the stand-by mode enable signal is deactivated.

8. The integrated circuit of claim 7, wherein the first switch unit includes a n-type transistor having a gate electrode receiving the inversion signal of the stand-by mode enable signal and connected between the first negative power supply voltage and the logic circuit, and
wherein the second switch unit includes at least one p-type transistor connected serially between the first negative power supply voltage and the logic circuit, each of the at least one n-type transistor having a gate electrode receiving the inversion signal of the stand-by mode enable signal.

9. The integrated circuit of claim 1, wherein the logic circuit includes an active region that is a part of the logic circuit activated to maintain the voltage level of the output signal in the stand-by mode, and wherein the active region of the logic circuit comprises:
at least one p-type transistor maintained to be turned on in the stand-by mode, each of the at least one p-type transistor having a second positive power supply voltage of the second power supply voltage from the power gating circuit at a drain electrode and a source electrode; and
at least one n-type transistor maintained to be turned on in the stand-by mode, each of the at least one n-type transistor having a first gate voltage provided from the drain electrode of a respective one of the at least one p-type transistor, the first gate voltage corresponding to the second positive power supply voltage.

10. The integrated circuit of claim 9, wherein each of the at least one n-type transistor has a second negative power supply voltage of the second power supply voltage from the power gating circuit at a drain electrode and a source electrode, and wherein each p-type transistor has a second gate voltage provided from the drain electrode of a respective one of the at least one n-type transistor, the second gate voltage corresponding to the second negative power supply voltage.

11. The integrated circuit of claim 9, wherein the logic circuit further includes an inactive region that is another part of the logic circuit deactivated in the stand-by mode, wherein the inactive region of the logic circuit includes at least one transistor turned off in the stand-by mode, and wherein the power gating circuit electrically isolates the inactive region of the logic circuit from the first power supply voltage in the stand-by mode.

12. The integrated circuit of claim 11, wherein said power gating circuit comprises:
a first power gating unit configured to electrically isolate the inactive region of the logic circuit from a first positive power supply voltage of the first power supply voltage in the stand-by mode; and
a second power gating unit configured to electrically isolate the inactive region of the logic circuit from a first negative power supply voltage of the first power supply voltage in the stand-by mode.

13. The integrated circuit of claim 1, wherein the first power supply voltage includes a first positive power supply voltage and a first negative power supply voltage, wherein the second power supply voltage includes a second positive power supply voltage and a second negative power supply voltage, wherein the logic circuit includes an inverter chain having first inverters and second inverters that are cascaded-coupled, and
wherein the power gating circuit applies the first positive power supply voltage and the first negative power supply voltage to the first and second inverters in the normal operation mode, applies the second positive power supply voltage instead of the first positive power supply voltage to the first inverters in the stand-by mode, and applies the second negative power supply voltage instead of the first negative power supply voltage to the second inverters in the stand-by mode, an output terminal of each first inverter being maintained at a logic high level, an output terminal of each second inverter being maintained at a logic low level.

14. The integrated circuit of claim 13, wherein the power gating circuit electrically isolates the first inverters from the first negative power supply voltage and electrically isolates the second inverters from the first positive power supply voltage.

15. A semiconductor device comprising:
a control circuit configured to generate a power gating signal activated in a normal operation mode and deactivated in a stand-by mode; and
an integrated circuit having a power gating function and configured to be controlled based on the power gating signal, the integrated circuit comprising
a logic circuit configured to generate an output signal based on an input signal and a first power supply voltage in the normal operation mode, and configured to maintain a voltage level of the output signal as a stand-by logic level based on a second power supply voltage in the stand-by mode, a magnitude of the second power supply voltage being smaller than a magnitude of the first power supply voltage; and
a power gating circuit configured to entirely apply the first power supply voltage to the logic circuit based on the power gating signal in the normal operation mode, and configured to partially apply the second power supply voltage to the logic circuit based on the power gating signal in the stand-by mode.

16. A semiconductor device comprising:
a logic circuit configured to generate an output signal based on an input signal in a normal operation mode, and configured to maintain a voltage level of the output signal as a stand-by logic level in a stand-by mode; and
a power gating circuit including
a first power gating unit configured to selectively apply a first positive power supply voltage or a second positive power supply voltage to a first circuit region of the logic circuit responsive to a stand-by mode enable signal, the second positive power supply voltage being smaller than the first positive power supply voltage,
a second power gating unit configured to selectively apply the first positive power supply voltage to a second circuit region of the logic circuit or to electrically isolate the second circuit region from the first positive power supply voltage, responsive to the stand-by mode enable signal,
a third power gating unit configured to selectively apply a first negative power supply voltage or a second negative power supply voltage to the second circuit region of the logic circuit responsive to a stand-by mode disable signal, the second negative power supply voltage being smaller than the first negative power supply voltage, and
a fourth power gating unit configured to selectively apply the first negative power supply voltage to the first circuit region of the logic circuit or to electrically isolate the first circuit region from the first negative power supply voltage, responsive to the stand-by mode disable signal.

17. The semiconductor device of claim 16, wherein the first power gating unit comprises a first p-type transistor and a first n-type transistor each having a gate electrode connected to the stand-by mode enable signal, and each respectively connected serially between the first positive power supply voltage and the first circuit region of the logic circuit.

18. The semiconductor circuit of claim 17, wherein the second power gating circuit comprises a second p-type transistor having a gate electrode connected to the stand-by mode enable signal, and connected serially between the first positive power supply voltage and the second circuit region of the logic circuit.

19. The semiconductor device of claim 16, wherein the third power gating unit comprises a first p-type transistor and a first n-type transistor each having a gate electrode connected to the stand-by mode disable signal, and each respectively connected serially between the first negative power supply voltage and the second circuit region of the logic circuit.

20. The semiconductor circuit of claim 19, wherein the fourth power gating circuit comprises a second n-type transistor having a gate electrode connected to the stand-by mode disable signal, and connected serially between the first negative power supply voltage and the first circuit region of the logic circuit.
